(19) United States
(12) Patent Application Publication
(10) Pub. No.: US 2023/0155227 A1
(43) Pub. Date: May 18, 2023

(54) EXCHANGEABLE SPLIT PROFILE BATTERY CELL CARRIER

(71) Applicant: SAMSUNG SDI CO., LTD., Yongin-si (KR)

(72) Inventor: Matthias PUCHER, Lebring (AT)

(21) Appl. No.: 18/055,300

(22) Filed: Nov. 14, 2022

(30) Foreign Application Priority Data
Nov. 15, 2021 (WO) 21208140.0
Nov. 14, 2022 (KR) 10-2022-0152037

(51) Int. Cl. H01M 50/207; H01M 50/244; H01M 50/249; H01M 50/26; H01M 10/625; H01M 10/613; H01M 10/6557

(52) U.S. Cl. CPC H01M 50/207; H01M 50/244; H01M 50/249; H01M 50/26; H01M 10/625; H01M 10/613; H01M 10/6557; H01M 2220/20

(57) ABSTRACT

A frame for a battery pack includes: a first end beam; a second end beam; and one or more intermediate beams between the first end beam and the second end beam. Each of the beams is orientated along a first direction that is perpendicular to a virtual plane, and includes: a first plate having a first side, and a second side opposite to the first side of the first plate; a second plate having a first side, and a second side opposite to the first side of the second plate; and a coupling means slidably coupling the second side of the first plate to the second side of the second plate to inhibit any displacement of the first plate relative to the second plate, except for a shifting of the first plate relative to the second plate in or against the first direction.

### CROSS-REFERENCE TO RELATED APPLICATIONS

This application claims priority to and the benefit of European Patent Application No. 21208140.0, filed in the European Patent Office on Nov. 15, 2021, and Korean Patent Application No. 10-2022-0152037, filed in the Korean Intellectual Property Office on Nov. 14, 2022, the entire content of both of which are incorporated by reference herein.

### BACKGROUND

### 1. Field

Aspects of embodiments of the present disclosure relate to a frame that provides structural support for a battery pack having at least two rows of stacked battery cells, and in particular, to a frame of a battery pack that allows for an easy exchange of an individual row of stacked battery cells. Aspects of embodiments of the present disclosure further relate to a battery pack having at least two rows of stacked battery cells, and to a vehicle that uses a power source including such a battery pack. Aspects of embodiments of the present disclosure further relate to a method of assembling trays of stacked battery cells.

### 2. Description of the Related Art

In the recent years, vehicles for transportation of goods and people have been developed using electric power as a source for motion. Such an electric vehicle is an automobile that is propelled by an electric motor that uses energy stored in rechargeable batteries. The electric vehicle may be solely powered by batteries, or may be a form of a hybrid vehicle that is additionally powered by, for example, a gasoline generator. Furthermore, the vehicle may include a combination of an electric motor and a combustion engine.

In general, an electric-vehicle battery (EVB) or a traction battery is a battery used to power the propulsion of battery electric vehicles (BEVs). Electric-vehicle batteries may differ from starting, lighting, and ignition batteries, in that they may be designed to give power over sustained periods of time. A rechargeable or secondary battery differs from a primary battery, in that the rechargeable or secondary battery may be repeatedly charged and discharged, while the primary battery may provide only an irreversible conversion of chemical to electrical energy. Low-capacity rechargeable batteries may be used as a power supply for small electronic devices, such as cellular phones, notebook computers, and camcorders, while high-capacity rechargeable batteries may be used as the power supply for electric vehicles, hybrid vehicles, and the like.

Typically, rechargeable batteries include an electrode assembly including a positive electrode, a negative electrode, and a separator interposed between the positive and negative electrodes, a case for receiving the electrode assembly, and an electrode terminal electrically connected to the electrode assembly. An electrolyte solution is injected into the case in order to enable charging and discharging of the battery via an electrochemical reaction of the positive electrode, the negative electrode, and the electrolyte solution. A shape of the case (e.g., cylindrical or rectangular) depends on the battery's intended purpose. Lithium-ion (and similar lithium polymer) batteries are widely used in laptops and consumer electronics, and dominate the most recent group of electric vehicles in development.

The above information disclosed in this Background section is for enhancement of understanding of the background of the present disclosure, and therefore, it may contain information that does not constitute prior art.

### SUMMARY

Rechargeable batteries may be used as a battery module, for example, for motor driving of a hybrid vehicle. The battery module may be formed of a plurality of unit battery cells that are connected in series and/or in parallel, so as to provide high energy density. In other words, the battery module may be formed by interconnecting the electrode terminals of the plurality of unit battery cells depending on a desired amount of power, and in order to realize a high-power rechargeable battery.

A battery pack is a set of any suitable number of battery modules that may be identical to each other, but may be different from each other. The battery modules may be configured in a series, parallel, or a mixture of both, to deliver the desired voltage, capacity, and/or power density. Components of the battery pack include the individual battery modules, and the interconnects, which provide electrical conductivity between them.

Mechanical integration of such a battery pack may use appropriate mechanical connections between the individual components thereof (e.g., the battery modules, and between the battery modules), and a supporting structure of the vehicle. These connections may remain functional and safe during an average service life of a battery system. Further, installation space and interchangeability requirements may need to be met, especially in mobile applications.

Mechanical integration of the battery modules may be achieved by providing a carrier framework, and by positioning the battery modules on the carrier framework. Fixing the battery cells or battery modules may be achieved by fitted depressions in the carrier framework, or by mechanical interconnectors such as bolts or screws. As another example, the battery modules may be confined by fastening side plates to lateral sides of the carrier framework. Further, cover plates may be fixed atop and below the battery modules.

The carrier framework of the battery pack may be mounted to a carrying structure of the vehicle. In a case where the battery pack is to be fixed at a bottom of the vehicle, the mechanical connection may be established from the bottom side by, for example, bolts passing through the carrier framework of the battery pack. The carrier framework is typically made of aluminum or an aluminum alloy to lower a total weight of the construction. Hereinafter, the carrier framework for a battery pack may also be referred to as a “frame.”

Battery systems according to a comparative example, despite any modular structure, usually includes a battery housing that serves as an enclosure to seal the battery system against an environment (e.g., an external environment), and provides structural protection to the battery system's components. Housed battery systems are typically mounted as a whole into their application environment (e.g., an electric vehicle or hybrid vehicle). Thus, replacement of defective system parts (e.g., a defective battery submodule) may first require dismounting of the entire battery system, and removal of its housing. Thus, even defects of small and/or cheap system parts may lead to dismounting and replacement of the complete battery system, and the separate repair of the defective parts. As high-capacity battery systems may be expensive, large, and heavy, such procedures may be burdensome, and the storage of the bulky battery systems (e.g., in a mechanic's workshop) may be difficult.

Further, to provide thermal control of the battery pack, a thermal management system may be used to safely operate and use the at least one battery module by efficiently emitting, discharging, and/or dissipating heat generated from the battery module's rechargeable batteries. When heat emission/discharge/dissipation is not sufficiently performed, temperature deviations occur between respective battery cells, such that the at least one battery module may not generate a desired amount of power. In addition, an increase of the internal temperature may lead to abnormal reactions occurring therein, and thus, charging and discharging performance of the rechargeable batteries may deteriorate, and the life-span of the rechargeable battery may be shortened. Thus, cell cooling for effectively emitting/discharging/dissipating heat from the battery cells may be desired.

Typical battery housings and/or frames may employ a certain number of aluminum extrusion profiles, which are used as longitudinal-beams and cross-beams, in order to achieve a rigid mechanical structure. Such aluminum extrusion profiles may also be used for the main support, and for cooling of the battery cells as well. Due to constant pressure for reducing overall costs and package space, the battery cells may typically be integrated as a so called “battery cell stack” directly between the “beams,” such as the aluminum extrusion profiles. Therefore, the battery cells may be joined (e.g., directly joined) to the beams (e.g., the carriers, the profiles, and the like) via a structural adhesive material.

Irrespective of whether the above-described stack-arrangements (e.g., the battery cell stacks) are separated by using one, two, or more beams, the number of beams used may be a compromise (e.g., a trade-off) in terms of the amount of required parts, manufacturing costs, package, safety, and possibility of a rework.

According to one or more embodiments of the present disclosure, a battery pack, and a frame for the battery pack, having one or more improved characteristics (e.g., amount of required parts, manufacturing costs, package, safety, and/or the possibility of a rework) when compared to those of the comparative example described above may be provided.

For example, in some embodiments, the battery pack, and the frame for the battery pack, may include two cost effective, very simple kinds of extrusion profiles (e.g., sub-beams), which may be easy to manufacture.

In some embodiments, a risk of a thermal propagation between two battery cell stacks at the same package space may be reduced.

In some embodiments, cooling means (e.g., as part of the thermal management system) may be implemented within the beams.

In some embodiments, a rigid connection between two sub-beams may be provided, such that the connected sub-beams may be considered as one single profile (e.g., one single beam).

In some embodiments, the battery pack, and the frame for the battery pack, may enable a total exchange of a battery cell stack, even in a case where the battery cells are glued/adhered directly to the profiles.

In some embodiments, the battery pack, and the frame for the battery pack, may allow for various flexibility, and in particular, may allow for the combination of various different types of beams (e.g., profiles), for example, such as beams that are especially adapted as a front-end beam and/or a rear-end beam (e.g., that are equipped with interfaces, sealing flanges, and/or the like), to be installed.

Accordingly, a very cost-effective battery/frame may be provided having higher safety performance at the same package space. Further, in a case of a failure occurring within a battery cell stack, in some embodiments, it may be possible to exchange the affected stack, even when the cells are glued to the beams (e.g., the profiles).

According to one or more embodiments of the present disclosure, a frame for providing structural support for a battery pack having at least two rows of stacked battery cells is provided.

According to one or more embodiments, the frame includes: a first end beam, a second end beam, and one or more intermediate beams. The beams may be arranged in parallel or substantially in parallel to each other on a virtual plane. The one or more intermediate beams are arranged between the first end beam and the second end beam, and each of the beams is orientated along a first direction. Each of the beams includes: a first plate having a first side, and a second side opposite to the first side of the first plate; a second plate having a first side, and a second side opposite to the first side of the second plate; and a coupling means for slidably connecting the second side of the first plate to the second side of the second plate, such that any displacement of the first plate relative to the second plate is inhibited, except for a shifting the first plate relative to the second plate in or against a suitable direction (e.g., a predefined or predetermined direction).

It should be noted that for one assembled beam (e.g., a beam with the respective first and second plates being connected to each other), the inner sides of the plates are labelled as the second sides, and the outer sides are labelled as the first sides.

According to one or more embodiments of the present disclosure a battery pack is provided.

According to one or more embodiments of the present disclosure, the battery pack includes at least two rows of stacked battery cells, and the frame. A number of intermediate beams included therein equals the number of rows of stacked battery cells minus one. Each of the rows of stacked battery cells is mounted between a pair of adjacent beams. Here, the term “beam” refers to any one of the first end beam, the second end beam, and the intermediate beams. The expression a “row of stacked battery cells being mounted between a pair of adjacent beams” refer, in particular, to the row of stacked battery cells that is held in place by any one of the adjacent beams. This may be performed simply by mechanical structures (e.g., using flanges) or by other methods as described in more detail below.

In an embodiment, the rows of stacked battery cells may each be mounted to the respective adjacent beams using adhesives.

According to one or more embodiments of the present disclosure, a vehicle using a power source comprising the battery pack is provided.

According to one or more embodiments of the present disclosure, a method of assembling trays of stacked battery cells for use in a battery pack is provided.

According to one or more embodiments of the present disclosure, the method includes: a1) providing at least two rows of stacked battery cells; a2) providing a first and second plate of a first end beam; a3) providing a first and second plate of a second end beam; and a4) providing a number of first plates of an intermediate beam and a number of second plates of an intermediate beam.

The number of first plates of an intermediate beam and the number of second plates of an intermediate beam may be equal to each other, and may be equal to the of rows of stacked battery cells minus one. Here, each of the plates has a first side and a second side. The first and second plate of the first end beam are configured for being connected (e.g., coupled or attached) to each other, with their respective second sides, to form the first end beam. The connecting inhibits any displacement of the respective first plate relative to the respective second plate, except for a shifting of the respective first plate relative to the respective second plate in or against a direction of the first end beam.

The first and second plates of the second end beam are configured for being connected (e.g., coupled or attached) to each other, with their respective second sides, to form the second end beam. The connecting inhibits any displacement of the respective first plate relative to the respective second plate, except for a shifting of the respective first plate relative to the respective second plate in or against a direction of the second end beam. Each of the first plates of an intermediate beam is configured for being connected (e.g., coupled or attached) with each of the second plates of an intermediate beam to form an intermediate beam. The second side of the respective first plate is connected (e.g., coupled or attached) to the second side of the respective second plate. The connecting inhibits any displacement of the respective first plate relative to the respective second plate, except for a shifting of the respective first plate relative to the respective second plate in or against a direction of the intermediate beam formed by the respective first and second plates.

In an embodiment, the method further includes: b) creating a first end tray by mounting one of the rows of stacked battery cells between the first side of the second plate of the first end beam and the first side of the first plate of an intermediate beam; c) creating a second end tray by mounting a further one of the rows of stacked battery cells between the first side of the second plate of an intermediate beam and the first side of the first plate of the second end beam; d) when the number of rows of stacked battery cells is larger than two: creating, for each of the remaining rows of stacked battery cells, an intermediate tray by mounting each of the rows of stacked battery cells, except for the rows of stacked battery cells that are already mounted in steps b and c, between the first side of the second plate of an intermediate beam and the first side of a first plate of a further intermediate beam.

According to one or more embodiments of the present disclosure, a method for assembling a battery pack with a frame is provided.

According to one or more embodiments of the present disclosure, the method includes: e) generating trays of stacked battery cells using the method described above; f) assembling the first end beam by connecting (e.g., coupling or attaching) the second side of the first plate of the first end beam with the second side of the second plate of the first end beam; g) assembling the second end beam by connecting (e.g., coupling or attaching) the second side of the first plate of the second end beam with the second side of the second plate of the second end beam; and h) when the number of rows of stacked battery cells equals two: connecting the first end tray with the second end tray by assembling the intermediate beam by connecting (e.g., by coupling or attaching) the respective second sides of the first and second plate of the intermediate beam to each other.

In an embodiment, the method may further include i) when the number of rows of stacked battery cells is larger than two: i1) connecting the first end tray with an intermediate tray by assembling an intermediate beam by connecting (e.g., coupling or attaching) the second side of the uncoupled first plate of the intermediate beam used in the first end tray with the second side of the second plate used in one of the intermediate trays; i2) when there is a further unconnected intermediate tray, connecting the further unconnected tray by assembling an intermediate beam by connecting (e.g., coupling or attaching) the second side of the uncoupled first plate of an intermediate beam used in the intermediate tray connected in the foregoing sub-step i1 to the second side of the second plate of an intermediate beam used in the further intermediate tray; i3) repeating sub-step i2 until there is no further unconnected intermediate tray; and i4) connecting the second end tray by assembling an intermediate beam by connecting (e.g., coupling or attaching) the second side of the uncoupled first plate of an intermediate beam used in the intermediate tray, which has been connected last in the foregoing sub-step i1 or i2, to the second side of the second plate of the intermediate beam used in the second end tray.

Accordingly, in one or more embodiments of the present disclosure, one or more of the following may be improved.

Decomposability: The trend is to glue battery cells directly to the cell frame (e.g., no more modules), and thus, it may be difficult to decompose the pack. However, according to one or more embodiments of the present disclosure, a row of stacked battery cells may include two “profile halves” (e.g., plates), each to the left and right of the battery cells, and thus, may be pulled out of the battery pack from the side.

Safety: Because there may be a minimum or reduced material connection between the two “profile halves” (e.g., the first and second plates), heat transfer may be reduced significantly. Consequently, thermal propagation between adjacent cell rows may be prevented or largely reduced.

Identical or substantially identical parts: In each profile (e.g., beam), the “profile halves” (e.g., plates) facing the battery cells may be the same kind of component as each other. The remaining “profile half” may then be selected depending on the installation location (e.g., either an “outer half” for establishing an exterior side of the total battery pack or an “inner half” facing the battery cells), when the beam is arranged between two rows of stacked battery cells.

However, the aspects and features of the present disclosure are not limited to those described above, and addition aspects and features of the present disclosure may be realized from the following detailed description, figures, and claims and their equivalents, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 illustrates a schematic cross-sectional view of an intermediate beam of a frame according to an embodiment of the present disclosure;

FIG. 2 schematically illustrates three perspective views (A), (B), and (C) of a first plate and a second plate to be assembled into an intermediate beam according to one or more embodiments of the present disclosure;

FIG. 3 illustrates an enlarged view of a cut-out of FIG. 1, and a schematic view of a dovetail joint;

FIG. 4 schematically illustrates different kinds of plates to be used in the frame according to one or more embodiments of the present disclosure;

FIG. 5 schematically illustrates different kinds of beams using combinations of the plates shown in FIG. 4;

FIG. 6 schematically illustrates a battery pack according to an embodiment of the present disclosure;

FIG. 7 schematically illustrates a split beam of the battery pack shown in FIG. 6;

FIG. 8 schematically illustrates a battery pack according to another embodiment of the present disclosure;

FIG. 9 schematically illustrates heat insulation provided by a beam of the frame according to one or more embodiments of the present disclosure;

FIG. 10 schematically illustrates adhesive layers used to glue battery cells to a beam of the frame according to one or more embodiments of the present disclosure;

FIG. 11 schematically shows an example of a coupling means according to an embodiment of the present disclosure;

FIG. 12 schematically shows an example of a coupling means according to another embodiment of the present disclosure; and

FIG. 13 schematically shows an example of a coupling means according to another embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the following, the terms “upper” and “lower” are defined with respect to the orientation of the illustrated subject-matter in the figures. If a Cartesian coordinate system is shown in a figure, the terms “upper” and “lower” are defined with respect to the x-axis of the coordinate system. For example, the upper cover is positioned at the upper part of the x-axis, whereas the lower cover is positioned at the lower part thereof.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that the terms “include,” “comprise,” “including,” or “comprising” specify a property, a region, a fixed number, a step, a process, an element, a component, and a combination thereof, but do not exclude other properties, regions, fixed numbers, steps, processes, elements, components, and combinations thereof. It will be further understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, if the term “substantially” is used in combination with a feature that could be expressed using a numeric value, the term “substantially” denotes a range of +/— 5% of the value centered on the value. The use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one or more embodiments of the present disclosure, an improved frame for providing structural support for a battery pack having at least two rows of stacked battery cells is provided. For example, in some embodiments, the frame may include a split-profile, such that the compromise (or trade-off) between the characteristics described above (e.g., the amount of required parts, manufacturing costs, package, safety, and/or the possibility of a rework) may be reduced.

As used herein, the expression “structural support” in particular refers to providing a suitable mechanical support, such that a supported member (e.g., the rows of battery stacks and/or each individual battery cell) are held in an essentially fixated geometrical position relative to each other. Here, the term “essentially” includes small changes in the geometry due to normal temperature changes, and changing mechanical loads exerted from the outside onto the frame may remain possible.

The phrase “row of stacked battery cells” denotes a row of battery cells, which may include battery cells having the same or substantially the same shape as each other, that are aligned along a suitable direction (e.g., a certain direction), one after the other or one on top of the other, so as to form one or more battery cell stacks. When the row of stacked battery cells include only a single stack, then the row of stacked battery cells may refer to the stack. However, when the row includes more than one battery cell stack, the battery cell stacks themselves may be stacked together in a direction perpendicular to or substantially perpendicular to a direction of the cell stacking in each of the individual cell stacks. Then the stack of battery cell stacks forms the “row of stacked battery cell stacks,” and the orientation of the cell stacking is defined as the orientation of the cell stacking in each of the individual cell stacks (which are oriented in parallel or substantially in parallel relative to each other in such a row).

Typically, the individual battery cells may have a prismatic shape. For example, the body of the cell may extend between two parallel bases (e.g., a ground base and a top base), and the two bases may be identically or substantially identically shaped (e.g., as a polygon, or as a circle or an ellipse). Then, the cells may be stacked simply by taking one of the cells and putting the ground base of any further cell on the top base thereof (e.g., of the preceding cell). Further, the battery cells may each be shaped as a right prism (e.g., a prism with a side face being perpendicular to or substantially perpendicular to each of the bases). In a battery pack, more than one row of stacked battery cells may be used.

In an embodiment, a coupling means of each of the beams of the frame may include: a first guiding means including one or more first guide rails; and a second guiding means including one or more second guide rails. Each of the first guide rails is fixedly arranged on the surface of the second side of the respective first plate, and extends linearly along a suitable direction (e.g., a predefined direction). Each of the second guide rails is fixedly arranged on the surface of the second side of the respective second plate, and extends linearly along the suitable direction (e.g., predefined direction). At least one of the first guide rails and at least one of the second guide rails are engaged with each other.

For example, for each of the coupling means, the number of first guide rails corresponds to the number of second guide rails. In such a case, each of the first guide rails on the respective first plate may be engaged with a matching one of the second guide rails. In some embodiments, however, the number of guide rails provided on the first plate of a beam may be different from the number of guide rails provided on the second plate of that beam. For example, different prefabricated plates may be used together, and there may be a first kind of pairs of first and second plates, each having two guide rails, and a second kind (e.g., a further kind) of pairs of first and second plates, each having only one guide rail. However, the positions of the guide rails on the plates may be chosen such that, for example, the first plate of the first kind is connectable to the second plate of the second kind, in that only one of the guide rails of the first plate becomes engaged with the single guide rail of the second plate. In the latter example, the other guide rail of the first plate may be unused. In an embodiment, for each of the coupling means, the number of the first guide rails is at least two, and the number of the second guide rails is at least two.

Each of the guide rails may be formed integrally (e.g., as one piece of material) with the respective plate on which the guide rail is arranged. Then, the plate together with the coupling means arranged thereon may be manufactured by extrusion. The material of some or each of the plates may include (e.g., may be) aluminum (Al). In this case, some or each of the plates may be manufactured as aluminum extrusion profiles.

In an embodiment, at least one pair of a first guide rail and a second guide rail that are engaged with each other may have the following properties. The first guide rail may exhibit a first cross-sectional profile in any suitable plane that is perpendicular to or substantially perpendicular to the predefined direction, and crossing (e.g., intersecting) the first guide rail, independent from the position of the plane with respect to the predefined direction. The second guide rail may exhibit a second cross-sectional profile in any suitable plane that is perpendicular to or substantially perpendicular to the predefined direction, and crossing (e.g., intersecting) the second guiding means, independent from the position of the plane with respect to the predefined direction. Further, either a shape of the first cross-sectional profile comprises a cavity with an opening and the second cross-sectional profile comprises a bulge fitting into the cavity, or the shape of the second cross-sectional profile comprises a cavity with an opening and the first cross-sectional profile comprises a bulge fitting into the cavity. In either case, the bulge is connected to the remaining first or second cross-section profile by a connection part passing through the opening of the cavity, and the bulge may have a size that is too large to be passed through the opening of the cavity.

In an embodiment, the coupling means of at least one of the beams may include at least one pair of a first guide rail and a second guide rail, the first guide rail and the second guide rail being engaged with each other using a dovetail joint.

In an embodiment, for each beam, one or more cooling channels may be arranged on the surface of the second side of the respective first plate. In an embodiment, for each beam, one or more cooling channels are arranged on the surface of the second side of the respective second plate. The cooling channels may be formed integrally with the respective plates on which they are arranged. In some embodiments, each of cooling channels extends linearly along the predefined direction. Then, some or each of the plates together with the respective coupling means and cooling channels may be manufactured by extrusion.

In an embodiment, for each of the intermediate beams, the first side of the respective first plate may be configured to provide support for a lateral side of a row of stacked battery cells, and the first side of the respective second plate may be configured to provide support for a lateral side of a further row of stacked battery cells. For the first end beam, the first side of the respective second plate may be adapted to provide support for a lateral side of a row of stacked battery cells. For the second end beam, the first side of the respective first plate may be adapted to provide support for a lateral side of a row of stacked battery cells.

In this context, the term “lateral side” of a row of stacked battery cells denotes a side of the row, which extends parallel to or substantially parallel to the direction in which the battery cells are stacked to form the row of stacked battery cells. Accordingly, the side face(s) of a row of stacked battery cells depends on the given shape of the battery cells that are stacked together to form the row of stacked battery cells. For example, if the individual battery cells each exhibit a cuboidal shape, the four side faces of the row of stacked battery cells each have a rectangular planer shape. In this case, the first sides of plates configured to provide support for a lateral side of a row of stacked battery cells may likewise exhibit a planar rectangular shape or a planer trapezoidal shape. However, if some side faces of the battery cells have a convex shape (e.g., if the cross-section of the cells resembles two lying letters “U” with their open sides put together), the first sides of plates configured to provide support for a lateral side of a row of stacked battery cells may have a complementary concave shape.

In an embodiment, for each of the intermediate beams, the first side of the respective first plate may be configured to provide support for each of a lateral side of a first row and a second row of stacked battery cells, and the first side of the respective second plate may be configured to provide support for each of a lateral side of the second row and a third row of stacked battery cells. For the first end beam, the first side of the respective second plate may be configured to provide support for a lateral side of the first row of stacked battery cells, and for the second end beam, the first side of the respective first plate may be configured to provide support for a lateral side of the third row of stacked battery cells.

In one or more embodiments, the support provided for lateral sides of a row of stacked battery cells by a first side of a plate may be realized by at least one flange. In an embodiment, the number of flanges arranged on that first side may be two. In this case, the flanges may be arranged on either edge of the first side along the predefined direction. Also, the two flanges may have a suitable distance between each other, which encompasses a lateral side of a row of stacked battery cells.

In an embodiment, for each of the beams, the surface of the second side of the first plate may have essentially a trapezoidal shape extending between two parallel edges, each being orientated along the predefined direction. Further, for each of the beams, the surface of the second side of the second plate may have essentially a trapezoidal shape extending between two parallel edges, each being orientated along the predefined direction. The trapezoidal shape may be, in particular, a rectangular shape. However, for example, to facilitate a mounting of the beams to front and rear bars oriented perpendicular to or substantially perpendicular to the predefined direction, and configured to hold each of the first end beam, the second end beam, and the intermediate beams in predefined positions (which will be described in more detail below), the rectangular shape of the plates may be prolonged at their respective ends in or against the predefined direction, so as to form mounting areas or the like, which may result in essentially the trapezoidal shape.

In an embodiment, for the first end beam, the first side of the respective first plate may be adapted for being mounted to predefined external structures. In an embodiment, for the second end beam, the first side of the respective second plate may be adapted for being mounted to predefined external structures. The predefined external structures may be, for example, parts of a housing configured to accommodate the frame, or parts of a rack configured to store several battery packs using the frame.

In an embodiment, the frame may further include a front bar. The front bar may be oriented perpendicular to or substantially perpendicular to the predefined direction, and may be configured to be mechanically connected to each of the respective proximal ends of the first end beam, the second end beam, and each of the intermediate beams, when viewed in the predefined direction. In an embodiment, the frame may further include a rear bar. The rear bar may be oriented perpendicular to or substantially perpendicular to the predefined direction, and may be configured to be mechanically connected to each of the respective distal ends of the first end beam, the second end beam, and each of the intermediate beams, when viewed in the predefined direction. Here, the term “proximal end” of the first end beam, the second end beam and each of the intermediate beams denotes an end of the respective beam that points into a direction opposite to (e.g., against) the predefined direction. Also, the term “distal end” of the first end beam, the second end beam, and each of the intermediate beams denotes an end of the respective beam that points into the predefined direction. The front and/or the rear bar may allow for holding each of the first end beam, the second end beam, and the intermediate beams in respective predefined positions. When using the front bar and the rear bar together in one frame, the front bar and the rear bar may be arranged to be parallel to or substantially parallel to each other.

The mounting of any one of the first end beam, the second end beam, and each of the intermediate beams to the front bar may be performed using a suitable connection (e.g., a screw joint or bolted connection) between the front bar and the respective first plate and/or the respective second plate. The mounting of any one of the first end beam, the second end beam, and each of the intermediate beams to the rear bar may be performed using a suitable connection (e.g., a screw joint or bolted connection) between the rear bar and the respective first plate and/or the respective second plate.

In one or more embodiments, mechanical structures such as holes for accommodating screws or bolts may be formed in at least some of the plates to facilitate the connecting procedure between a beam and a bar. In some embodiments, each of these mechanical structures may be arranged on the surface of a second side of the respective plate on which it is arranged. Each or of these mechanical structures may be formed integrally with the respective plates onto which it is arranged. In one or more embodiments, these mechanical structures may be realized by through-hole channels linearly extending along the predefined direction, and may be formed integrally with at least some of the plates. In one or more embodiments, plates including the through-hole channels may be manufactured by extrusion techniques.

In one or more embodiments, the first end beam, the second end beam, and each of the intermediate beams may be mounted to the front bar and/or the rear bar with the following orientations. The first side of the second plate of the first end beam faces the adjacent intermediate beam. The first side of the first plate of the intermediate beam adjacent to the first end beam faces the first end beam. The first side of the first plate of each intermediate beam faces the first side of the second plate of an adjacent beam being oriented in parallel to or substantially in parallel to that intermediate beam. The first side of the second plate of each intermediate beam faces the first side of the first plate of an adjacent beam oriented in parallel to or substantially in parallel to that intermediate beam. Finally, the first side of the first plate of the second end beam faces the first side of the second plate of the adjacent intermediate beam. As used herein, the expression “faces” may consider the members of the frame, independent from whether or not rows of stacked battery cells are mounted into the frame.

The above and other aspects and features of the present disclosure will now be described in more detail hereinafter with reference to the figures.

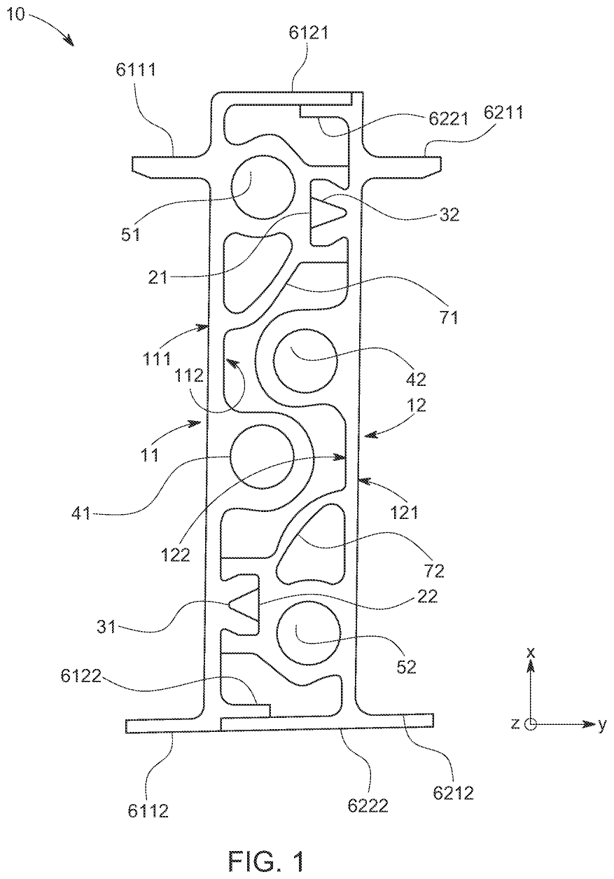

FIG. 1 illustrates a schematic cross-sectional view of an intermediate beam 10 of a frame according to an embodiment of the present disclosure.

Referring to FIG. 1, the intermediate beam 10 includes a first plate 11 (e.g., on the left side in the figure), and a second plate 12 (e.g., on the right side in the figure). Both plates 11, 12 have a rectangular or substantially rectangular shape (e.g., an essentially rectangular shape) extending perpendicular to or substantially perpendicular to the drawing plane of the figure. In the following, sides of the first and second plates, which form the exterior of the intermediate beam 10, will be described as the “first sides” of the respective plates, and sides of the first and second plates, which face each other, will be described as the “second sides” of the respective plates. In other words, in the figure, the left side of the first plate 11 is the first side 111 of the first plate 11, and the right side of the first plate 11 is the second side 112 of the first plate 11. Similarly, the right side of second plate 12 is the first side 121 of the second plate 12, and the left side of second plate 12 is the second side 122 of the second plate 12.

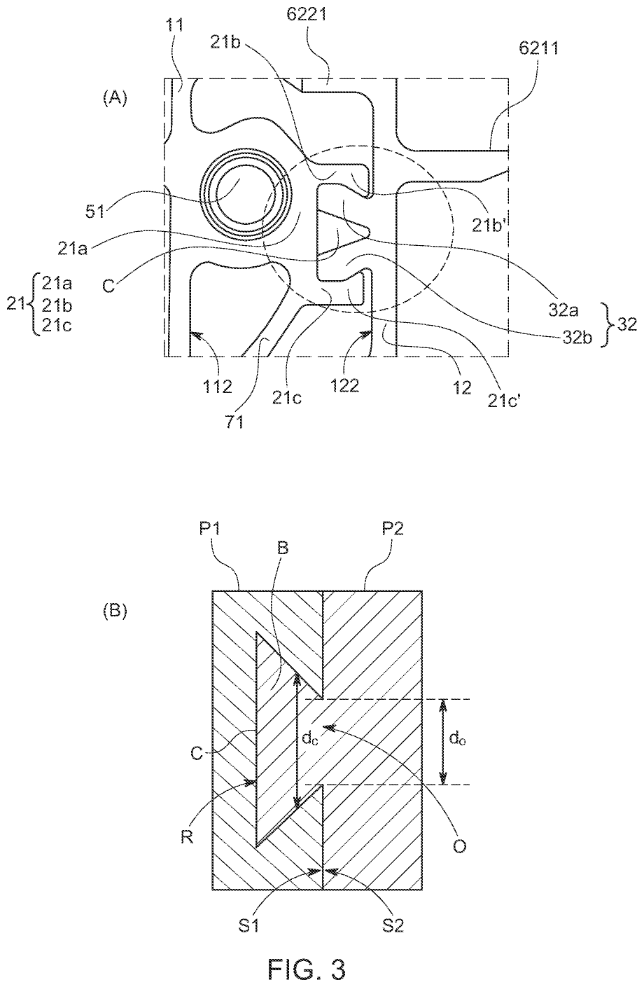

The first plate 11 and the second plate 12 are connected to (e.g., coupled to or attached to) each other by a coupling means, which is shown in the example of FIG. 1 as being formed by (e.g., as being built by) two pairs of guide rails, each of the pairs of guide rails establishing a connection realized by a so-called dovetail joint. The dovetail joint establishes a connection by engaging a linearly extending groove (as one guide rail) with a likewise linearly extending tongue (as another guide rail). This is described in more detail below with reference to FIG. 3, and in particular, with regards to the shape of the guide rails. In an embodiment, an upper dovetail joint is realized by groove 21 and tongue 32 (e.g., the tongue 32 being split into a V-like shape), both of which extend linearly in a direction perpendicular to or substantially perpendicular to the drawing plane of the figure. For example, the groove 21 is arranged on the second side 112 of the first plate 11, and the matching tongue 32 is arranged at an opposite position to the groove 21 on the second side 122 of the second plate 12. A lower dovetail joint has the same or substantially the same structure, but in a reversed order with respect to the plates (e.g., a groove 22 thereof is arranged on the second side 122 of second plate 12, and a tongue 31 thereof is arranged on the second side 112 of first plate 11).

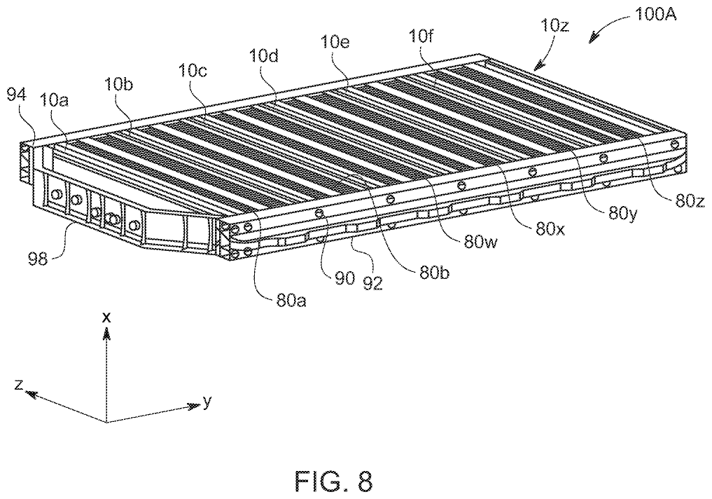

In some embodiments, the groove 21 may not be directly arranged on the second side 112 of the first plate 11, but may be fixated to a structure formed by a circumferential wall of a through-hole 51 together with a reinforcing strut 71. Both the circumferential wall of the through-hole 51 and the reinforcing strut 71 may be arranged directly on the second side 112 of the first plate 11. Likewise, the groove 22 may not be directly arranged on the second side 122 of the second plate 12, but may be fixated to a structure formed by a circumferential wall of a through-hole 52 together with a reinforcing strut 72. Both the circumferential wall of the through-hole 52 and the reinforcing strut 72 may be arranged directly on the second side 122 of the second plate 12. The through-holes 51 and 52 may accommodate screws or bolts used for fixating the intermediate beam 10 to a front bar 92 or a rear bar 94, as described in more detail below with reference to FIG. 8.

Also, arranged on the second sides 112, 122 of the plates 11, 12 are first and second cooling channels 41, 42, respectively. The cooling channels 41, 42 may be arranged directly on the respective plates 11, 12, such that battery cells of a battery pack mounted adjacent to the first sides 111, 121 of the plates 11, 12 are separated from coolant fluids flowing through the cooling channels 41, 42 by a relatively thin material layer of the first plate 11 and the second plate 12, respectively. Thus, a maximum or increased exchange between the battery cells and the coolant fluids may be achieved (e.g., a maximum or increased cooling effect is acquired). In the example of the intermediate beam 10 shown in FIG. 1, the first cooling channel 41 that is arranged on the second side 112 of the first plate 11 is positioned upwardly and displaced with a respective position of the second cooling channel 42 arranged on the second side 122 of the second plate 12. The reason is that each of cooling channels 41, 42 may use, in a horizontal direction (e.g., a y direction), more space than half of the distance between the first and second plates 11, 12. In a vertical direction (e.g., an x direction), the exterior surfaces of the circumferential walls of the cooling channels 41, 42 may come close to each other, but in an embodiment, they may not come into contact with each other.

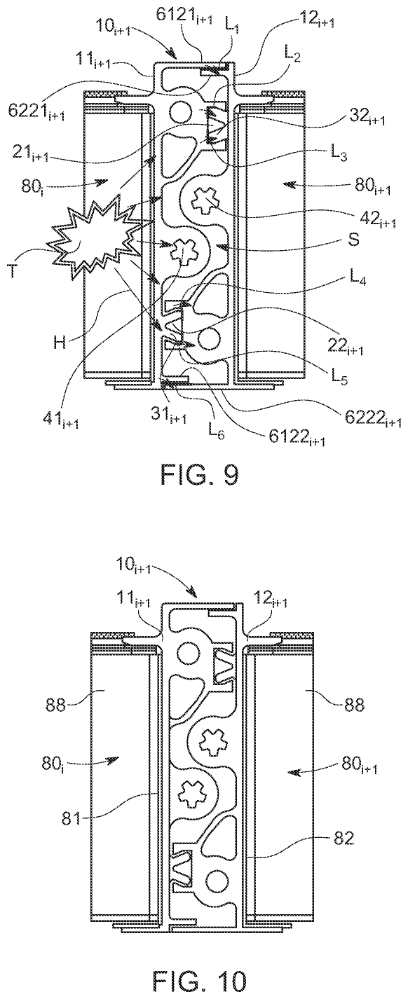

A remaining space between the first and second plates 11, 12 is left void (e.g., there may be no further solid structures provided in this space). However, the space between the first and second plates 11, 12 may be filled with a gas, for example, such as air. This may help to minimize or reduce the heat exchange between the first plate 11 and the second plate 12. This will be described in more detail below with reference to FIG. 9.

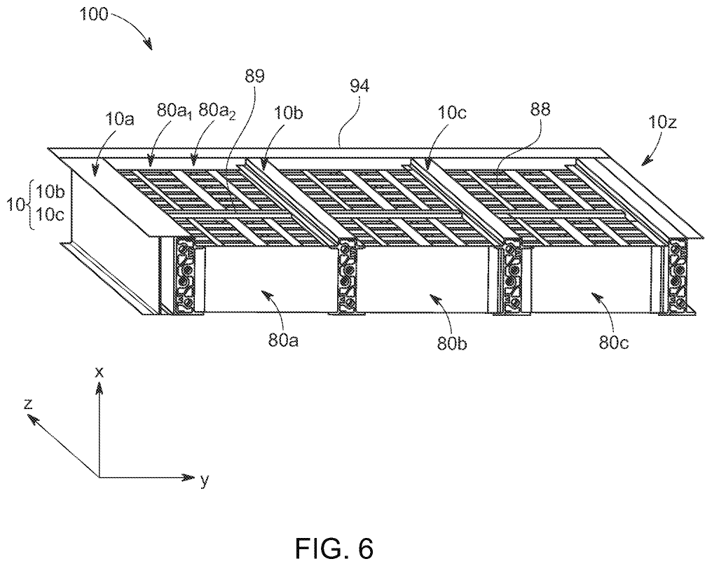

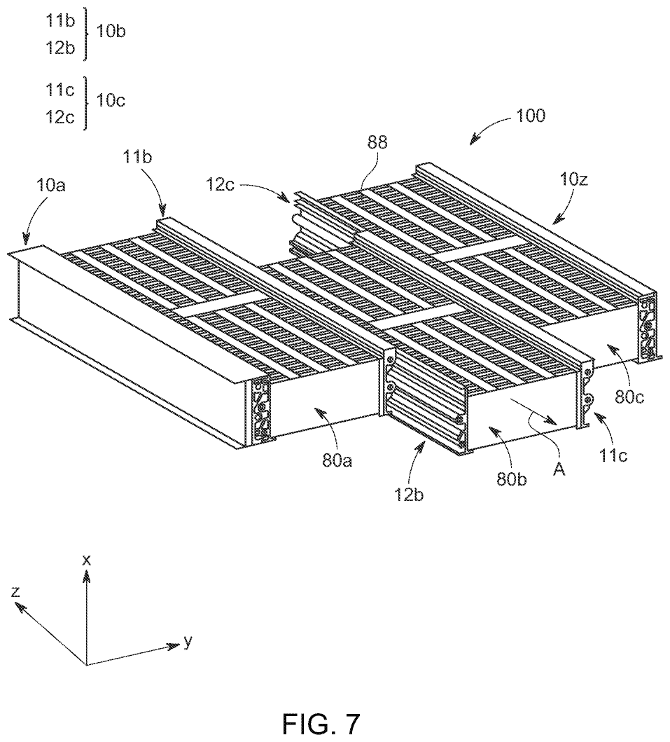

The outer sides of the intermediate beam 10 illustrated in FIG. 1 (e.g., the first side 111 of the first plate 11 and the first side 121 of the second plate 12) are each adapted to provide direct mechanical support to a row of stacked battery cells (e.g., see FIGS. 6 and 7). For example, a first outer pair of flanges 6111, 6112 protrudes from the first side 111 of first plate 11, and similarly, a second outer pair of flanges 6211, 6212 protrudes from the first side 121 of second plate 12. The first outer pair of flanges 6111, 6112 protruding from the first side 111 of the first plate 11 includes an upper outer flange 6111 arranged adjacent to (e.g., close to) the upper edge of first plate 11, and a lower outer flange 6112 arranged at the lower edge of first plate 11. Correspondingly, the second outer pair of flanges 6211, 6212 protruding from the first side 121 of second plate 12 includes an upper outer flange 6211 arranged adjacent to (e.g., close to) the upper edge of second plate 12, and a lower outer flange 6212 arranged at the lower edge of second plate 12. Each of the outer flanges 6111, 6112, 6211, 6212 extends linearly in a direction perpendicular to or substantially perpendicular to the drawing plane of the figure over the length of the respective plate on which the flange is arranged. Then, a right lateral side of a row of stacked battery cells may be fitted between the first outer pair of flanges 6111, 6112. Likewise, a left lateral side of a row of stacked battery cells may be fitted between the second outer pair of flanges 6211, 6212. The lateral sides of the rows of stacked battery cells that are placed adjacent to the respective first sides 111, 121 of the first and second plates 11, 12 are held in place by the outer flanges 6111, 6112, 6211, 6212 in a vertical direction (e.g., the x direction) with respect to the orientation depicted in FIG. 1.

To close the space between the first and second plate 11, 12 also in a vertical direction, pairs of inner flanges may also be arranged on plates 11, 12, respectively. In more detail, an upper inner flange 6121 protruding from the upper edge of the second side 112 of the first plate 11 extends to (e.g., reaches to) the upper edge of the second side 122 of the second plate 12. The upper inner flange 6121 is supported from below by a further upper inner flange 6221 protruding from the second side 122 of the second plate 12 from a position close to the upper edge of second plate 12. In a similar manner, a lower inner flange 6222 protruding from the lower edge of the second side 122 of the second plates 12 extends to (e.g., reaches to) the lower edge of the second side 112 of the first plate 11. The lower inner flange 6222 is supported from above by a further lower inner flange 6122 protruding from the second side 112 of the first plate 11 from a position close to the lower edge of first plate 11. Each of the inner flanges 6121, 6122, 6221, 6222 extends linearly in a direction perpendicular to or substantially perpendicular to the drawing plane of the figure over the length of the respective plate on which the flange is arranged.

In an embodiment, the cross-sectional profile of each of the plates 11, 12 shown in FIG. 1, together with their respective structures arranged thereon (e.g., see above), remains constant over the whole extension of the plates 11, 12 in the direction perpendicular to or substantially perpendicular to the drawing plane of the figure. Then, each of the plates 11, 12 may be manufactured by extrusion techniques. For example, each of the plates 11, 12 may be an aluminum extrusion profile.

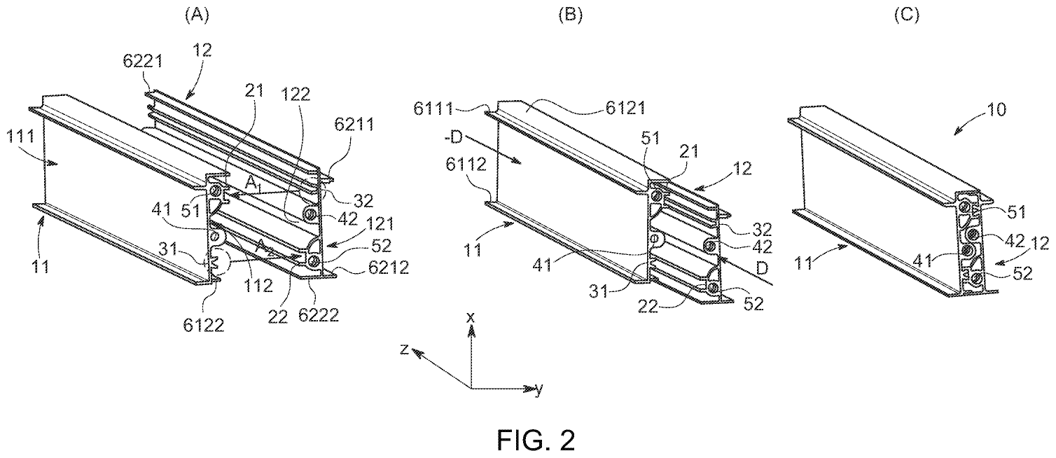

While the above-described structures that are arranged on the second side 112 of the first plate 11 may, in a horizontal direction, overlap with structures arranged on the second side 122 of the second plate 12, or even contact (e.g., touch) structures arranged on the second side 122 of the second plate 12 (e.g., as in the case of the upper inner flanges 6121, 6221 or the lower inner flanges 6122, 6222), the structures arranged on the first plate 11 may not be fixedly connected to the structures arranged on the second plates 12. For example, in some embodiments, the first plate 11 and the second plates 12, with each of their respective structures, may remain displaceable relative to each other in a direction (e.g., a z direction) perpendicular to or substantially perpendicular to the drawing plane of FIG. 1. This will be described in more detail below with reference to FIG. 2.

FIG. 2 schematically illustrates three perspective views (A), (B), and (C) of a first plate 11 and a second plate 12 to be assembled into an intermediate beam 10. The Cartesian coordinate system having the axes x, y, z depicted in FIG. 2 applies to any one of these views (A), (B), and (C). In the three perspective views (A), (B), and (C), the first plate 11 and the second plates 12 are shown in different positions relative to each other. The three views (A), (B), and (C) may also be interpreted as different states of a process of assembling the intermediate beam 10 as shown in the view (C). A cross-sectional cut through the assembled intermediate beam 10 as depicted in view (C) corresponds to the view shown in FIG. 1.

In each of the tree perspective views (A), (B), and (C), each of the plates 11, 12 extends in a direction parallel to or substantially parallel to the x-z-plane of the coordinate system. Both plates 11, 12 are elongated in the z-direction. The linear extension along the z-direction of the structures arranged on the plates 11, 12 and described above with respect to FIG. 1 is illustrated at least for the first outer pair of flanges 6111, 6112 protruding from the first side 111 of the first plate 11, the inner flanges 6221, 6222 protruding from the second side 122 of the second plate 12, the through-hole 52 of the second plate 12, the cooling channel 42 of the second plate 12, and the tongue 32 of the upper dovetail joint and groove 22 of the lower dovetail joint.

The view (A) in FIG. 2 shows the first plate 11 oriented relative to the second plate 12, such that the respective second sides 112, 122 of the plates 11, 12 are orientated to be in parallel or substantially in parallel with each other and to face each other. Highlighted by dashed circles are the (lower) tongue 31 arranged on the second side 112 of the first plate 11 and protruding towards the right, as well as the (upper) tongue 32 arranged on the second side 122 of the second plate 12 and protruding towards the left. At suitable positions (e.g., with respect to the x-z-plane of the coordinate system) on the respective opposite plates 11, 12 are arranged the (lower) groove 22 on the second side 122 of the second plate 12, and the (upper) groove 21 on the second side 112 of the first plate 11. In a state in which the plates 11, 12 are connected (e.g., coupled or attached) to each other so as to form the intermediate beam 10 shown in the view (C) of FIG. 2, the upper tongue 32 on the second plate 12 is embraced by the upper groove 21 on the first plate 11, and thus, establishes a coupling of the two plates 11, 12 to each other at the upper halves of the plates 11, 12. The assignment of the upper tongue 32 to the upper groove 21 is indicated by an arrow extending from the dashed circle around the upper tongue 32 and pointing to the upper groove 21. Likewise, the pair of the lower tongue 31 and the lower groove 22 establishes a coupling of the two plates 11, 12 to each other at the lower halves of the plates 11, 12, when the lower tongue 31 is embraced by the lower groove 22 as shown in the view (C) of FIG. 2. In the view (A) of FIG. 2, the assignment of the lower tongue 31 to the lower groove 22 is indicated by an arrow extending from the dashed circle around the lower tongue 31 and pointing to the lower groove 22.

The dovetail joints employed as the coupling means to connect the first and second plates 11, 12 to each other are described in more detail below with reference to FIG. 3. As described in more detail below with reference to FIG. 3, one feature of the employed dovetail joints is that any displacement of the first and second plates 11, 12 relative to each other with respect to the x-y plane of the coordinate system may be inhibited by the dovetail joints, while at the same time, movement of the first and second plates 11, 12 relative to each other with respect to the z-axis of the coordinate system may be allowed. Likewise, it may not be possible to establish the coupling means by the dovetail joints by simply pressing the respective tongues into the respective grooves. As a consequence, it may also not be possible to connect the respective second sides 112, 122 of the first and second plates 11, 12 by simply pressing them against each other in the direction of the x-axis of the coordinate system. Rather, the first and second plates 11, 12 may be connected to (e.g., coupled to or attached to) each other by aligning the plates 11, 12 along the z-direction, such that, when viewed in the z-direction, the cross-sectional profile of the (upper) tongue 32 is embraced within the cross-sectional profile of the (upper) groove 21, and similarly, the cross-sectional profile of the (lower) tongue 31 is embraced within the cross-sectional profile of the (lower) groove 22, as effectively shown in FIG. 1. It should be noted that from FIG. 1, it may not be determined whether the plates 11, 12 are in a coupled state, or if they are in a decoupled state but aligned one after the other in a direction perpendicular to or substantially perpendicular to the drawing plane of FIG. 1. Subsequently, the plates 11, 12 may be connected to (e.g., coupled to or attached to) one another by moving the plates 11, 12 against each other in a direction parallel to or substantially parallel to the z-axis of the coordinate system, thereby, telescoping the (upper) tongue 32 into the (upper) groove 21, and similarly, the (lower) tongue 31 into the (lower) groove 22. This is shown in the view (B) of FIG. 2, where the arrow D indicates that the second plate 12 is shifted into the z-direction, and the arrow −D indicates that the first plate 11 is shifted against the z-direction. Note that during the whole process of telescoping the plates 11, 12 into each other (e.g., see the view (B) of FIG. 2), a view upon the ensemble of the first and second plates 11, 12 from a direction along the z-axis of the coordinate system may yield a constant picture, such as the picture shown in FIG. 1.

After having been completely telescoped into one another, the ensemble of the first and second plates 11, 12 is shown in the final state depicted in the view (C) of FIG. 2 (e.g., the state wherein the first and second plates 11, 12 are assembled into the intermediate beam 10).

In summary with reference to FIG. 2, the first plate 11 and the second plate 12, which may each be realized by simple aluminum extrusion profiles, may be telescoped into each other by using established shapes for accurate (linear-)guiding such as the “dovetail guide” shown in the examples of FIGS. 1 and 2. Once the first plate 11 and the second plate 12 are slipped into each other, the resulting beam 10 (e.g., see the view (C) in FIG. 2) may be formed, and when employed in a frame for a battery pack (as described in more detail below), may be implemented as a rigid single-piece profile (e.g., beam).

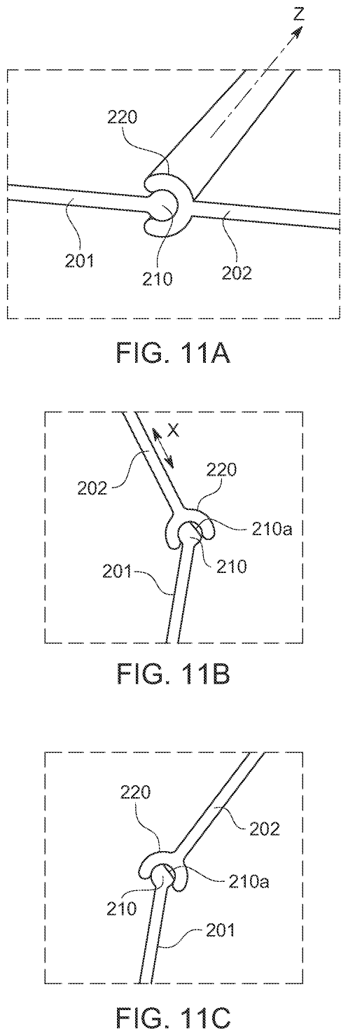

While some examples of the coupling means described above employ the dovetail joints, the present disclosure is not limited to the use of dovetail joints. Any other suitable joint inhibiting movements between the plates that are assembled to form a beam, except for a longitudinal movement of the plates relative to each other, may be employed as the coupling means, as long as it suitably provides for the desired demands of stability. Other examples of joints that may be used as the coupling means according to various embodiments of the present disclosure are described in more detail below with reference to FIGS. 11, 12, and 13.

An embodiment of a coupling mechanism (e.g., a coupling means), which may be employed to connect the respective second sides 112, 122 of the first plate 11 and the second plate 12 to each other, will now be described in more detail with reference to FIG. 3. FIG. 3 illustrates an enlarged view of a cut-out of FIG. 1, and a schematic view of a dovetail joint. In particular, FIG. 3 shows a view (A) that is an enlarged cut-out view of an upper area of the intermediate beam 10 depicted in FIG. 1, and focuses on the upper dovetail joint (highlighted by the dashed circle) described above with reference to FIG. 1. A general principle of a dovetail joint is shown in a schematic view (B) of FIG. 3.

A first structure P1 and a second structure P2, which may be in contact (e.g., may be in touch) with each other by respective surfaces S1, S2 (wherein the touch may be reduced, however, to a minimum; see below), includes matching features C, B that are in engagement with each other. In more detail, the first structure P1 includes a cave C having an opening O, and the second structure P2 includes a bulge B protruding form-fittingly through the opening O in the cave C of the first structure P1. The cave C is formed such that a space within the cave C becomes narrower when viewed from a rear end R of the cave C into a direction pointing to the opening O. In other words, with respect to the orientation of the figure, a diameter dc of the cave C measured in the vertical direction may decrease as the horizontal position of the measurement approaches the opening O arranged opposite to the rear end R with respect to the position of the cave C. The hollow space of the cave C may exhibit a conical shape that tapers in the direction pointing from the rear end R to the opening O (e.g., the inner surface of the cave C has a conical shape). Further, the bulge B arranged on the second structure P2 exhibits the same conical shape tapering in the direction pointing from the rear end R to the opening O, but in an inverted manner (e.g., the outer surface of the bulge B has a conical shape). At its narrowest site, the bulge B is connected to the second structure P2. Accordingly, the bulge B that is accommodated in the cave C may not escape out of the cave C through the opening O, as at certain horizontal positions, the diameter of the bulge (e.g., being equal to or substantially equal to the diameter dc of cave C measured at the same horizontal position) is larger than the diameter do of the opening O. Thus, the first structure P1 and the second structure P2 are held in fixed positions relative to each other with respect to the two dimensions spanned by the drawing plane of figure by the engagement of the cave C and the bulge B with each other. Due to the above-described tapered shape resembling a dovetail, the connection generated by the cave C and the bulge B is generally termed a dovetail joint.

As applied to an embodiment of the present disclosure, each of the first and second structure P1, P2, as well as the cave C and the bulge B, are elongate structures extending along the direction perpendicular to or substantially perpendicular to the drawing plane of the figure, such that the cross-sectional profile of the ensemble of the structures (as shown in the view (B) of FIG. 3) remains constant for the cross-sectional profiles on any intersecting plane parallel to the drawing plane, as long as the intersecting plane intersects with the ensemble of these structures. As a consequence of this geometry, the first structure P1 and the second structure P2 may be moved relative to each other (e.g., the first and second structure P1, P2 are slidable or shiftable with respect to each other) in a direction perpendicular to or substantially perpendicular to the drawing plane of the figure, while at the same time—as described above—the first structure P1 and the second structure P2 remain in fixed positions relative to each other with respect to the drawing plane. This effect is exploited in the example of a coupling mechanism used in the intermediate beam 10 depicted in FIG. 1 as shown in more detail in the view (A) of FIG. 3. Despite some minor structural variations in comparison to the connection illustrated in the view (B) of FIG. 3, the coupling mechanism shown in the view (A) of FIG. 3 (e.g., in the area highlighted by the dashed circle) may be a dovetail joint like that shown in the view (B) of FIG. 3.

In more detail, as shown in the cross-sectional cut view of (a part of) the intermediate beam 10 as depicted in the view (A) of FIG. 3, a ground part 21a and two walls 21b, 21c are formed, so as to build a groove 21 extending along the direction perpendicular to or substantially perpendicular to the drawing plane. In the figure, the ground part 21a extends in the vertical direction, whereas each of the two walls 21b, 21c extend in the horizontal direction. The groove 21 corresponds to the cave C in the view (B) of FIG. 3, and the opening is formed between the right edges of the two walls 21b, 21c. A conical part of the cave realized by groove 21 is built by end parts 21b′, 21c′ of the two walls 21b, 21c, in that the end parts 21b′, 21c′ each have an inclined surface (e.g., that is inclined with respect to each other and also inclined to the horizontal direction of the view (A) of FIG. 3), such that in the area of the end parts 21b′, 21c′, the hollow space in the groove 21 tapers in a direction pointing from the ground part 21a (corresponding to the rear end R in the view (B)) to the opening between the edges of the two walls 21b, 21c. As described above with reference to FIG. 1, the groove 21 is fixated on the second side 112 of the first plate 11 of the intermediate beam 10 in an indirect manner (e.g., the groove 21 is formed on the right side of the circumferential wall of through-hole 51, and is additionally supported by a reinforcing strut 71, the circumferential wall of the through-hole 51 as well as the reinforcing strut 71 being directly fixated on the second side 112 of the first plate 11).

Further, a V-shaped tongue 32 extending linearly along the direction perpendicular to or substantially perpendicular to the drawing plane is arranged on the second side 122 of the second plate 12 of the intermediate beam 10, the tongue 32 being formed by a first inclined part 32a and a second inclined part 32b. The tongue 32 protrudes, from the second side 122 of the second plate 12, into the groove 21. In more detail, the first inclined part 32a and the second inclined part 32b are inclined with respect to each other (e.g., so as to form a lying letter V with the tip thereof pointing to the right in the view (A)), and are also each inclined relative to the horizontal direction of the view (A). With the tip of the letter V formed by the inclined parts 32a, 32b, each of the inclined parts 32a, 32b are fixedly connected to the second side 122 of the second plate 12. The inclination of the first inclined part 32a corresponds to the inclination of the inner surface of the end part 21b′ of upper wall 21b of groove 21, and similarly, the inclination of the second inclined part 32b corresponds to the inclination of the inner surface of the end part 21c′ of lower wall 21c of groove 21. It should be noted that, in the area close to the ground part 21a of the groove 21, the inclination of the surfaces of the inclined parts 32a, 32b may deviate, which is, however, not important for the functioning of the described coupling mechanism. As a consequence of the corresponding inclinations of end parts 21b′, 21c′ of the walls 21b, 21c of the groove 21 and the surfaces of the inclined parts 32a, 32b abutting against the end parts 21b′, 21c′, a similar effect of engaging may be caused as described with reference to the view (B) of FIG. 3 with respect to the cave C and the bulge B, although, due to the void space between the two inclined parts 32a, 32b, the tongue 32 may not exhibit the compact shape (unlike the compact shape of the bulge B of the view (B) shown in FIG. 3). In more detail, the first plate 11 and the second plate 12 may be moved relative to each other (e.g., the first and second plates 11, 12 are slidable or shiftable with respect to each other) in a direction perpendicular to or substantially perpendicular to the drawing plane of the figure, while at the same time, the first plate 11 and the second plate 12 are held in fixed positions relative to each other with respect to the drawing plane by the dovetail joint realized by the groove 21 and the tongue 32.

In the following, in order to avoid an unduly restriction of the disclosure to the use of dovetail joints as the coupling mechanisms (e.g., the coupling means), the generic expression “guide rail” will be used to denote both parts of a coupling arranged on the first plate 11 (e.g., the groove 21) as well as parts of that coupling arranged on the second plate 12 (e.g., the tongue 32). In this context, the expression “guide rail” is to be construed in a broader sense (e.g., such that it is not restricted to a single linearly extending member with a rectangular cross-section, but may also include composed structures like the groove 21 or the tongue 32).

Depending on application needs required in specific situations, different shapes of the beams (e.g., the profiles) may be used. For example, the outer beams of the battery pack (e.g., a leftmost beam 10a and a rightmost beam 10z in FIG. 8) may have one side adapted to provide mechanical support to a row of stacked battery cells and an opposite side adapted to terminate the battery pack, thereby, possibly providing additional structures, such as sealing flanges, for an interface to a top and bottom cover of the battery pack. These beams are referred to as “end beams” in the following. Other beams, however, may be suitably shaped, such that they provide mechanical support to two adjacent rows of stacked battery cells positioned at opposite sides of the respective beam. These beams are referred to as “intermediate beams” throughout this disclosure. One example of the intermediate beam has been described above with reference to FIGS. 1 to 3.

Furthermore, for the sake of brevity, hereinafter, a plate having one side configured to provide mechanical support to a row of stacked battery cells shall be referred to as a “cell supporting plate,” and a plate not having a side configured to provide mechanical support to a row of stacked battery cells shall be referred to as an “end plate.”

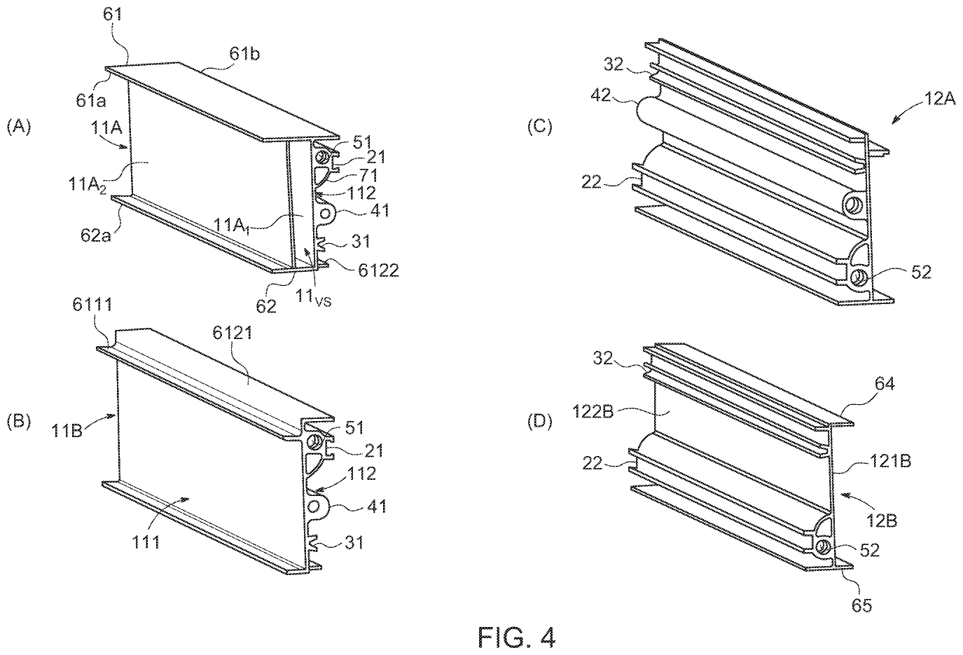

Different kinds of beams may be simply assembled by using different types of first and second plates, and each type of the first plate is combinable with (e.g., may be coupled to or attached to) each type of the second plate. Examples of different kinds of plates will be described in more detail below with reference to FIG. 4.

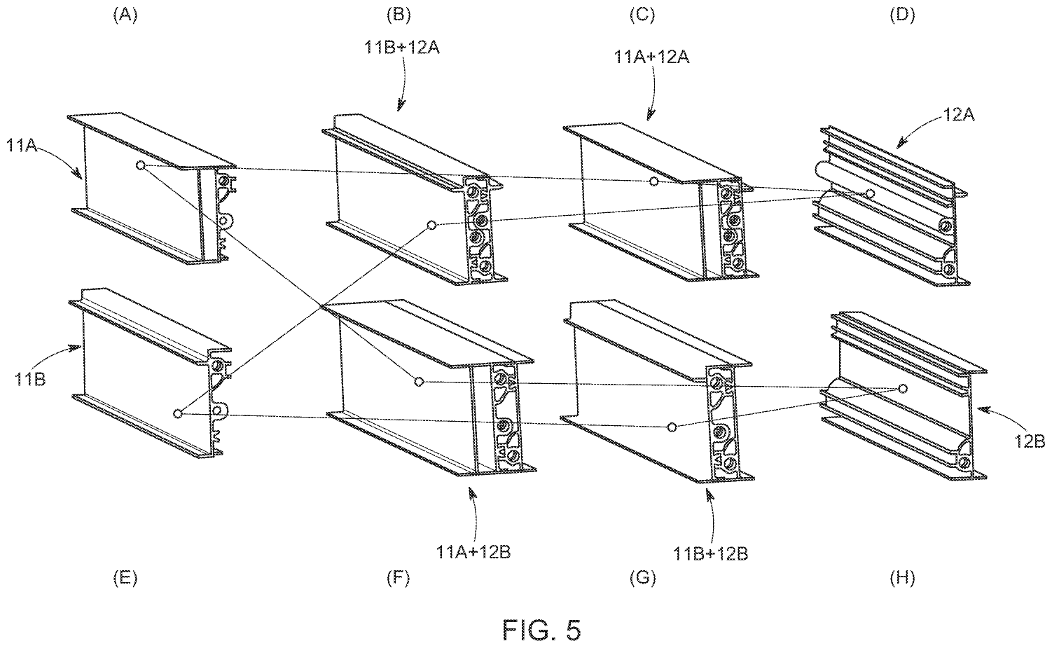

Hereinafter, for convenience, various views shown in the figures will be designated with the figure number followed by the view designation. For example, a view (A) shown in FIG. 4 may be designated as FIG. 4A, and likewise, a view (B) shown in FIG. 5 may be designated as FIG. 5B.

FIG. 4 schematically illustrates different kinds of plates to be used in the frame according to one or more embodiments of the present disclosure. FIG. 5 schematically illustrates different kinds of beams using combinations of the plates shown in FIG. 4.

On the left side of FIG. 4, two different types of first plates are illustrated, whereas on the right side of FIG. 4, two different types of second plates are illustrated. In more detail, a type of a first plate 11B depicted in FIG. 4B corresponds to the first plate 11 shown in FIGS. 1 to 3 above, and a type of a second plate 12A depicted in FIG. 4C corresponds to the second plate 12 shown in FIGS. 1 to 3 above. As described above with reference to FIG. 1, the first plate 11 as well as the second plate 12 may include the side adapted to provide mechanical support to a row of stacked battery cells. Accordingly, the type of the first plate 11B depicted in FIG. 4B as well as the type of the second plate 12A depicted in FIG. 4C may constitute cell supporting plates.

A type of the first plate 11A illustrated in FIG. 4A, however, may constitute an end plate. In more detail, the first plate 11A is realized as a double plate (e.g., the first plate 11A includes two parallel sub-plates 11A₁ and 11A₂, and a void space 11vs between the two parallel sub-plates 11A₁ and 11A₂). By varying a thickness of the void space 11vs, the overall thickness of first plate 11A may be adapted according to desired geometrical dimensions of the battery pack, when first plate 11A is used as part of a frame of the battery pack (e.g., see the first beam 10a in the battery pack of FIG. 8). Also, the void space 11vs provides additional thermal insulation between the exterior of the battery pack and the inside of the battery pack where battery cells 88 are arranged (e.g., see FIG. 6).

The sub-plates 11A₁ and 11A₂ are held in position by two closing members 61, 62, which also confine the void space 11vs in the vertical direction with respect to the orientation of first plate 11A in FIG. 4A. The upper closing members 61 extends, in a horizontal direction, into flanges 61a, 61b protruding at the upper edge of plate 11A to the left and to the right. Unlike the left upper flange 6111 of the first plate 11 depicted in FIGS. 1 to 3 and 4B, the left upper flange 61a of the first plate 11A is directly arranged at the top edge of first plate 11A. However, the right upper flange 61b of first plate 11A exhibits a shape corresponding to that of the right upper flange 6121 of first plate 11. The left upper flange 61a and left lower flange 62a may be used as an interface for mounting the end plate 11A to a top cover (and a bottom cover, respectively, of the battery pack. Further, each of the structures provided on the right surface of the right sub-plate 11A₁ (e.g., the right upper flange, through-hole 51, upper groove 21, reinforcing strut 71, cooling channel 41, lower tongue 31, and the right lower flange 6122) correspond to respective structures provided on the surface of the second side 112 of first plate 11 as described above with reference to FIG. 1. Accordingly, the type of first plate 11B illustrated in FIG. 4A may be readily connected (e.g., coupled or attached) to the second plate 12A depicted in FIG. 4C, which is the same or substantially the same as the second plate 12 illustrated in FIGS. 1 to 3 (e.g., see FIG. 5C).

Similarly, a type of the second plate 12B illustrated in FIG. 4D constitutes an end plate. The flanges 64, 65 protruding from the first side (e.g., the right side) of the second plate 12B are positioned and formed in a similar manner as those of the flanges 61a, 62a protruding to the left side from first plate 11A depicted in FIG. 4A, except for their orientation to the right. On the other hand, the structures arranged on the second side (e.g., the left side) the second plate 12B each correspond to respective structures arranged on the second side of second plate 12 as described above with reference to FIG. 1, with the only difference being that the cooling channel 42 may be omitted in the case of the type of the second plate 12B illustrated in FIG. 4D. In other words, because the second plate 12B is an end plate, unlike the second plate 12 shown in FIGS. 1 to 3 and 4C, there may be no battery cells next to the right side of second plate 12B when in use. The type of second plate 12B illustrated in FIG. 4D may be readily connected (e.g., coupled or attached) to the first plate 11B depicted in FIG. 4B, which is the same or substantially the same as the first plate 11 illustrated in FIGS. 1 to 3 (e.g., see FIG. 5G). However, it should be noted that the type of the second plate 12B illustrated in FIG. 4D may also be connected (e.g., coupled or attached) to the type of first plate 11A illustrated in FIG. 4A, although this combination may be rarely used as a combination of two end plates (e.g., see FIG. 5F).

A compilation of the different possible combinations of connecting (e.g., coupling or attaching) each of the two types of first plates 11A, 11B illustrated in FIGS. 4A and 4B, to different ones of the two types of second plates 12A, 12B illustrated in FIGS. 4C and 4D is shown in FIG. 5. Each of four resulting combinations thereof may yield a specific type of beam. The first column and the last column shown in FIG. 5 illustrate the two types of first plates and the two types of second plates, respectively, which are depicted in the left column and the right column of FIG. 4, respectively. In more detail, FIG. 5A shows the first end plate 11A of FIG. 4A, FIG. 5E shows the first cell supporting plate 11B of FIG. 4B, FIG. 5D shows the second cell supporting plate 12A of FIG. 4C, and FIG. 5H shows the second end plate 12B of FIG. 4D.

Further, the different beams assembled by the four possible combinations of the above-described types of plates are shown in the second and third columns of FIG. 5. In more detail, FIG. 5B illustrates the first cell supporting plate 11B (e.g., see FIGS. 4B/5E) being connected (e.g., coupled or attached) to the second cell supporting plate 12A (e.g., see FIGS. 4C/5D). The beam resulting from the combination shown in FIG. 5B corresponds to the intermediate beam 10 described above with reference to FIGS. 1 to 3. Further, FIG. 5C illustrates the first end plate 11A (e.g., see FIGS. 4A/5A) being connected (e.g., coupled or attached) to the second cell supporting plate 12A (e.g., see FIGS. 4C/5D). The combination shown in FIG. 5C results in a first end beam 10a illustrated in FIGS. 6 to 8 as the beam terminating battery pack on the left side (e.g., see below).

FIG. 5F illustrates the first end plate 11A (e.g., see FIGS. 4A/5A) being connected (e.g., coupled or attached) to the second end plate 12B (e.g., see FIGS. 4D/5H). The combination shown in FIG. 5F may be rare, and may not be normally used in a frame for supporting rows of stacked battery cells, as this is a combination of two end plates, and thus, none of the lateral sides of the beam shown in FIG. 5F may be configured to provide support (e.g., structural support or technical support) to a row of stacked battery cells. However, the type of beam shown in FIG. 5F may be used in other situations, such as providing additional support to the frame as a whole when being mounted (e.g., in a housing or the like). FIG. 5G illustrates the first cell supporting plate 11B (e.g., see FIGS. 4B/5E) being connected (e.g., coupled or attached) to the second end plate 12B (e.g., see FIGS. 4D/5H). The combination shown in FIG. 5G results in the second end beam 10z illustrated in FIGS. 6 to 8 as the beam terminating battery pack on the right side (e.g., see below).

FIG. 6 schematically illustrates a perspective view of a battery pack 100 according to an embodiment of the present disclosure.

Referring to FIG. 6, three rows of stacked battery cells 80a, 80b, 80c are mounted into the frame using the beams described above with reference to FIGS. 1 to 5. Each of the beams is orientated along the direction of the z-axis of the coordinate system depicted in the figure. Here, each row of stacked battery cells includes two battery cell stacks arranged in parallel with each other and adjacent to each other with respect to the y-axis. For example, the first row of stacked battery cells 80a (e.g., the leftmost row of stacked battery cells in FIG. 6) includes a first battery cell stack 80a₁ and a second battery cell stack 80a₂, each being orientated along the z-axis. In an isolated state (e.g., when not mounted in a frame), the first and second battery cell stacks 80a₁, 80a₂ may be held together by a holding means 89, which may also provide further means of the row of stacked battery cells 80a, for example, such as electric terminals. The second row of stacked battery cells 80b and the third row of stacked battery cells 80c are assembled in the same or substantially the same (e.g., in a similar) manner.

In more detail, the first row of stacked battery cells 80a is mounted between a first end beam 10a that corresponds to the end beam shown in FIG. 5C, and a first intermediate beam 10b that corresponds to the intermediate beam shown in FIGS. 2C and 5B. As described above, the first end beam 10a is assembled by connecting (e.g., coupling or attaching) the first end plate 11A of FIG. 5A with the second cell supporting plate 12A of FIG. 5D, and the first intermediate beam 10b is assembled by connecting (e.g., coupling or attaching) a first cell supporting plate 11B of the type shown in FIG. 5E with the second cell supporting plate 12A of the type shown in FIG. 5D. Further, the second row of stacked battery cells 80b is mounted between the first intermediate beam 10b and a second intermediate beam 10c, which has an assembly that is the same or substantially the same as that of the first intermediate 10b. The third row of stacked battery cells 80c is mounted between the second intermediate beam 10c and a second end beam 10z that corresponds to the end beam shown in FIG. 5G. As described above with reference to FIG. 5, the second end beam 10z is assembled by connecting (e.g., coupling or attaching) the first cell supporting plate 11B of FIG. 5E with the second end plate 12B of FIG. 5H.

Visible at the front side of the depicted battery pack 100 is both of the lateral sides (e.g., the left and right sides in the figure) of each row of stacked battery cells 80a, 80b, 80c, along the direction of the x-axis of the coordinate system, between embracing flanges protruding towards the respective row of stacked battery cells from the cell supporting plates abutting the respective row of stacked battery cells. The flanges have been described above with reference to FIGS. 1 and 5. Additionally, the lateral sides of each row of stacked battery cells 80a, 80b, 80c may each be glued to the respective abutting plate. At the rear side of the battery pack 100 illustrated in FIG. 6, each of the beams 10a, 10b, 10c, 10z are mounted, with their respective rear ends (or distal ends), to the rear bar 94 extending parallel to or substantially parallel to the y-axis of the coordinate system, and thus, perpendicular to or substantially perpendicular to each of the beams 10a, 10b, 10c, 10z. Also, a front bar may be mounted in a similar manner to each of the respective front end (or proximal ends) of the beams 10a, 10b, 10c, 10z (e.g., see FIG. 8). In the embodiment of FIG. 6, the frame is built by first and second end beams 10a, 10z, the two intermediate beams 10b, 10c, the rear bar 94, and possibly also the front bar (not shown).

As described above with reference to FIGS. 1 to 5, each of the beams 10a, 10b, 10c, 10z is assembled from a pair of plates that are connected (e.g., coupled or attached) together, such that any displacement of the respective plates relative to each other in a direction perpendicular to the z-axis is inhibited. Thus, each of the rows of stacked battery cells 80a, 80b, 80c is held, by the frame, in a fixed position relative to the direction of the x-axis (e.g., the vertical direction) as well as in a fixed position relative to the direction of the y-axis (e.g., the horizontal direction). However, in each beam, the respective first and second plates thereof may be connected (e.g., may be coupled or attached) to each other, such that they may be movable relative to each other in a direction parallel to or substantially parallel to the z-axis of the coordinate system. Accordingly, at least one of the plates of the respective beam may not be held in a fixed position with respect to the z-direction by means of the rear bar 94 or the front bar. In other words, if desired, a plate may be configured to be moved such as to be detached from the rear bar 94 and/or the front bar. Also, at least one of the rear bar 94 and, if applicable, the front bar may be demounted from the battery pack 100 to give way for the movement of the plates in a direction parallel to or substantially parallel to the z-axis. Thus, for the following, any possible mounting of beams 10a, 10b, 10c, 10z to a rear bar and/or the front bar is neglected.

Due to the above-described moveability of the two plates of a beam relative to each other, each of the rows of stacked battery cells 80a, 80b, 80c may be pulled out of the battery pack 100. This is schematically illustrated in FIG. 7. FIG. 7 illustrates that the second row of stacked battery cells 80b has been pulled to the front with respect to the remaining parts of the battery pack 100. In other words, starting from the position illustrated in FIG. 6, the second plate 12b of the first intermediate beam 10b may be shifted against the z-direction of the coordinate system relative to the first plate 11b of first intermediate beam 10b. Likewise, the first plate 11c of the second intermediate beam 10c may be shifted against the z-direction relative to the second plate 12c of second intermediate beam 10c.

In other words, the second row of stacked battery cells 80b together with the second plate 12b of first intermediate beam 10b and the first plate 11c the second intermediate beam 10c may form (e.g., may be regarded as) a drawer or tray, which may be pulled out of the battery pack 100 in a direction indicated by the arrow A, and/or, if the “tray” is already pulled out as illustrated in FIG. 7, may be pushed back into the battery pack 100 against the direction indicated by the arrow A. It should be appreciated, however, that the tray including the second row of stacked battery cells 80b may also be removed from the battery pack 100, and may be replaced by a further tray assembled in the same or substantially the same manner to have the same or substantially the same geometry as that of the tray with the row of stacked battery cells 80b. Accordingly, the battery pack 100 may be easily repaired, for example, in the case of a defective second row of stacked battery cells 80b or the like.

FIG. 7 schematically illustrates a split beam of the battery pack shown in FIG. 6. In FIG. 7, a tray including the second row of stacked battery cells 80b together with the second plate 12b of the first intermediate beam 10b and the first plate 11c the second intermediate beam 10c is shown as being pulled out of the battery pack 100. It should be understood, however, that each of the other trays (e.g., the tray including the first row of stacked battery cells 80a together with respective first and second plates of the respective adjacent beams 10a, 10b, and the tray including the third row of stacked battery cells 80c together with respective first and second plates of the respective adjacent beams 10z, 10c) may also be pulled out of the battery pack 100 or pushed into the battery pack 100 in the same or substantially the same manner as that shown in FIG. 7. Accordingly, the replacement of the first row of stacked battery cells 80a or the third row of stacked battery cells 80c may also be easily performed with the frame and the battery pack 100 depicted in FIG. 7.

FIG. 8 schematically illustrates a battery pack according to another embodiment of the present disclosure. The battery pack 100A shown in FIG. 8 includes six rows of stacked battery cells 80a, 80b, 80w, 80x, 80y, 80z orientated in parallel to or substantially in parallel to each other in the direction of the z-axis the coordinate system. Similar to the embodiment shown in FIG. 6, each of the six rows of stacked battery cells 80a, 80b, 80w, 80x, 80y, 80z is mounted between two beams (e.g., one beam attached to the left lateral side of the respective row of stacked battery cells, and a further beam attached to the right lateral side of the respective row of stacked battery cells). In more detail, the first row of stacked battery cells 80a (e.g., counted from the left to the right of the figure) is mounted between the first end beam 10a and the first intermediate beam 10b in the same or substantially the same fashion as that of the first row of stacked battery cells 80a of the embodiment of the battery pack 100 described above with reference to FIG. 6. Similarly, the sixth row of stacked battery cells 80z is mounted between the fifth intermediate beam 10f and the second end beam 10z in the same or substantially the same fashion as that of the third row of stacked battery cells 80c of the embodiment of the battery pack 100 described above with reference to FIG. 6. Further, each of the second, third, fourth, and fifth row of stacked battery cells 80b, 80w, 80x, 80y is mounted between two intermediate beams that are attached to the respective lateral sides of the respective row of stacked battery cells.

Each of the beams 10a, 10b, 10c, 10d, 10e, 10f, 10z is orientated along the direction of the z-axis of the coordinate system. The rear ends (e.g., the distal ends) of the beams are each mounted to a rear bar 94 orientated perpendicular to or substantially perpendicular to the beams along the direction of the y-axis. Likewise, the front ends (e.g., the proximal ends) of the beams are each mounted to a front bar 92 orientated parallel to or substantially parallel to the rear bar 94. Accordingly, the whole ensemble of beams, bars, and rows of stacked battery cells extends on a plane parallel to or substantially parallel to the y-z-plane of the coordinate system. Each of the front and rear bars 92, 94 may include a series of through-holes 90, through which screws or bolts may be guided so as to penetrate into respective through-holes arranged in the plates of the beams, for example, as illustrated in FIG. 1. For example, the front bar 92 may be mounted to the front end (e.g., the proximal end) of the first intermediate beam 10b by a screw or bolt guided through the through-hole 90 visible on the front side of front bar 92, the screw or bolt then penetrating into the upper through-hole 51 arranged on the second side 112 of the first plate 11 of the first intermediate beam 10b, which corresponds to the intermediate beam 10 shown in FIG. 1.

With the above description concerning the beams as each being assembled using a pair of coupled plates (e.g., see the description as to FIGS. 1 to 5) and the description as to FIG. 7, it follows that each of the rows of stacked battery cells 80a, 80b, 80w, 80x, 80y, 80z together with the plates of the beams to which the respective row of stacked battery cells is attached, forms of a drawer or tray which may be pulled out of the battery stack 100A or pushed into the battery stack 100A, when the plates connected to the respective row of stacked battery cells are not fixated to the front bar 92 and/or the rear bar 94, and at least one of the front bar 92 and the rear bar 94 is demounted from the battery pack 100A.

A grip or handle 98 may also be mounted onto the battery pack in order to facilitate pulling out the battery pack from a housing where the battery pack may be accommodated, or to put it back again into the housing. Also, further means used for the battery pack, such as electric terminals and the like, may be arranged on the grip or handle 98. In the battery pack 100A depicted in FIG. 8, the grip or handle 98 is mounted to the left ends of the front and rear bar 92, 94.

FIG. 9 schematically illustrates heat insulation provided by a beam of the frame according to one or more embodiments of the present disclosure.

FIG. 9 schematically illustrates the heat propagation between two neighboring rows of stacked battery cells 80ᵢ, 80ᵢ₊₁ through an intermediate beam 10ᵢ₊₁ of the frame according to one or more embodiments of the present disclosure. In the example shown in FIG. 9, the intermediate beam 10ᵢ₊₁ corresponds to the intermediate beam 10 shown in FIGS. 1 and 2, and may be any one of the intermediate beams 10b, 10c used in the battery pack 100 of FIGS. 6 and 7, or any one of the intermediate beams 10b, 10c, 10d, 10e, 10f used in the embodiment of the battery pack 100A shown in FIG. 8.

The safety of the battery pack depends on its ability to avoid or at least to decelerate the heat propagation from a row of stacked battery cells affected by an abnormal thermal event (e.g., such as a thermal run-away) to neighboring rows of stacked battery cells in order to avoid or at least to decelerate a spread of the thermal event within the battery pack. Thus, it may be desirable for the beams, such as the intermediate beams, to provide a high degree of heat insulation. Good heat insulation is provided by vacuum or gases, such as air. As illustrated in FIG. 9, a space S (e.g., most of the space S) between the first plate 11ᵢ₊₁ and the second plate 12ᵢ₊₁ of the intermediate beam 10ᵢ₊₁ may be left void, and thus, filled with air. The cooling channels (e.g., the circumferential walls thereof) 41ᵢ₊₁, 42ᵢ₊₁ arranged on the first plate 11ᵢ₊₁ and the second plate 12ᵢ₊₁, respectively, do not come into mechanical contact with each other. Indeed, the contact points (e.g., the only contact points) between the first plate 11ᵢ₊₁ and the second plate 12ᵢ₊₁ are established by the flanges and the dovetail joints. In more detail, a mechanical contact area L₁ is established between the upper inner flanges 6121ᵢ₊₁, 6221ᵢ₊₁ protruding from the second sides of first plate 11ᵢ₊₁ and the second plate 12ᵢ₊₁, respectively. Similarly, a further mechanical contact area L₆ is established between the lower inner flanges 6122ᵢ₊₁, 6222ᵢ₊₁ protruding from the second sides of first plate 11ᵢ₊₁ and the second plate 12ᵢ₊₁, respectively. Also, there are mechanical contact areas L₂, L₃ between the groove 21ᵢ₊₁ and the tongue 32ᵢ₊₁ of the upper dovetail joint, and further contact areas L₄, L₅ between the groove 22ᵢ₊₁ and the tongue 31ᵢ₊₁ of the lower dovetail joint of intermediate beam 10ᵢ₊₁.

Accordingly, in case of the thermal event T, such as a thermal run-away occurring (e.g., at the left row of stacked battery cells 80ᵢ abutting to the first plate 11ᵢ₊₁, and thus, immediately heating the first plate 11ᵢ₊₁ as indicated by the arrows H), the heat propagation to the second plate 12ᵢ₊₁ and then further to the right side of stacked battery cells 80ᵢ₊₁ is largely inhibited by the void space between the two plates 11ᵢ₊₁, 12ᵢ₊₁. The heat exchange between the plates is essentially restricted to the above-identified six contact areas L₁, L₂, L₃, L₄, L₅, L₆, where the two plates 11ᵢ₊₁, 12ᵢ₊₁ are in direct mechanical contact with each other. This is indicated by the small arrows being based in the contact areas L₁, L₂, L₃, L₄, L₅, L₆, which also indicate the respective direction of the heat propagation. However, as can be seen from the figure, the total area built by the areas L₁, L₂, L₃, L₄, L₅, L₆ is small in comparison to the total area of the second sides of each of the plates 11ᵢ₊₁, 12ᵢ₊₁. Thus, the intermediate beam 10ᵢ₊₁ may provide an extremely high degree of heat insulation. Hence, due to a structure of the intermediate beam 10ᵢ₊₁ in the battery pack as described above with reference to FIGS. 6 to 8, an expansion or propagation of a thermal event from one affected row of stacked battery cells to other rows of stacked battery cells may be inhibited or reduced.

Accordingly, as shown in FIG. 9, in the case of thermal events, such as a thermal run-away within one row of stacked battery cells, the split beams (e.g., profiles) may reduce or minimize the heat impact to neighboring rows of stacked battery cells, because there may be minor contact surfaces within the beams (e.g., between the plates, which the beams are assembled from), as shown by the contact areas L₁, L₂, L₃, L₄, L₅, L₆ and indicated by the respective arrows in these contact areas.

FIG. 10 schematically illustrates adhesive layers used to glue battery cells to a beam of the frame according to one or more embodiments of the present disclosure.

FIG. 10 schematically illustrates a fixation of rows of stacked battery cells (e.g., all or at least a part of the battery cells included in each of these rows of stacked battery cells) to an intermediate beam 10ᵢ₊₁ corresponding to the intermediate beam 10 shown in FIGS. 1 and 2. In the example shown in FIG. 10, a first layer of adhesive 81 is used to glue the left row of stacked battery cells 80ᵢ, with its right lateral side, to the first side (e.g., the left side) of the first plate 11ᵢ₊₁. Similarly, a second layer of adhesive 82 is used to glue the right row of stacked battery cells 80ᵢ₊₁, with its left lateral side, to the first side (e.g., the right side) of second plate 12ᵢ₊₁. Thus, in addition to the mechanical support to the rows of stacked battery cells provided by the flanges of a beam protruding from the respective first sides of the plates (e.g., as described above with reference to FIG. 1), in some embodiments, chemical means may be further used for the fixation of the rows of stacked battery cells to the beam.

Even when the rows of stacked battery cells are fixated as shown in FIG. 10, it may be possible to draw the rows of stacked battery cells out of the battery pack as illustrated in FIG. 7. For example, it may not be necessary to remove the adhesive layers between a certain row of stacked battery cells and the two beams to which it is fixated, because the plates to which the row of stacked battery cells is fixated are pulled out of the battery pack together with the row of stacked battery cells by exploiting the assembly of the beams as described above, and thus, two plates may be telescoped into one another (e.g., as shown in FIGS. 2B and 7) albeit the rows of stacked battery cells being fixated thereto.

Therefore, even if a failure occurs within a row of stacked battery cells or within a battery cell module, it may be possible to easily exchange the defective unit, even if the rows of stacked battery cells and/or the individual battery cells 88 are joined to the respective adjacent beams with structural adhesives, such as the adhesive layers 81, 82 shown in FIG. 10.

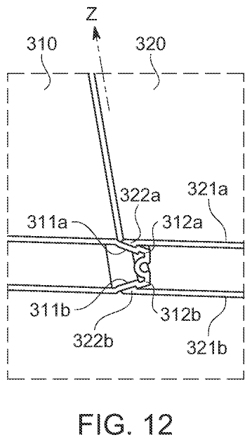

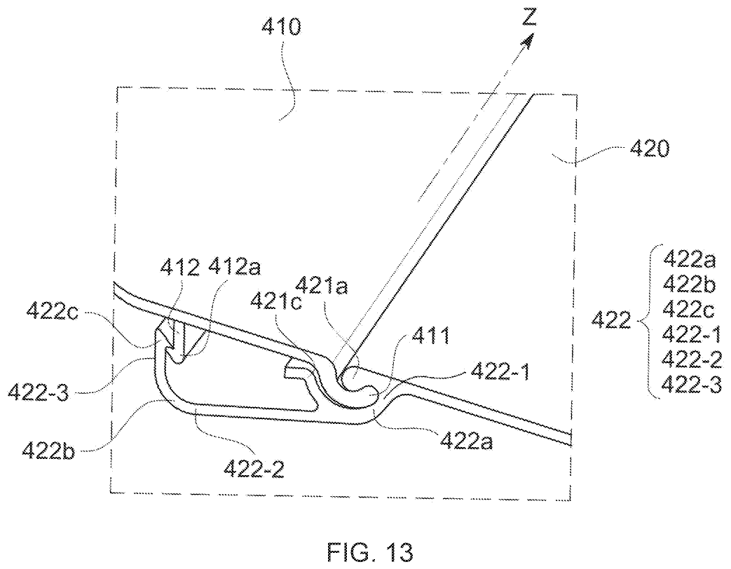

FIG. 11 schematically shows an example of a coupling means according to an embodiment of the present disclosure. FIG. 12 schematically shows an example of a coupling means according to another embodiment of the present disclosure. FIG. 13 schematically shows an example of a coupling means according to another embodiment of the present disclosure.

As described above with reference to FIG. 3, there are various embodiments of the coupling means that allow for a linearly slidable connection between two members (e.g., such as the plates) along or against one direction (e.g., the z direction), but that also inhibit any displacement of the two members relative two each other in or against other directions.

A few such examples of the coupling means are schematically illustrated in FIGS. 11, 12, and 13, which may be used instead of, or in addition to, the dovetail joints described above with reference to FIG. 3. In more detail, a simple joint may be used as shown in FIGS. 11A through 11C. The illustrated joint in FIGS. 11A through 11C allows for the connecting (e.g., the coupling or attaching) of a first member 201 and a second member 202 to each other. The first member 201 may include a first linear edge 210 being formed to be thickened and having a bulge shape. The second member 202 may include a second linear edge 220 having a tube-like structure with a slit therethrough. Through the slit, the first member 201 extends into an interior of the second linear edge 220, such that the first linear edge 210 is accommodated in the interior of the second linear edge 220. In other words, the first linear edge 210 of the first member 201 and the second linear edge 220 of the second member 202 are in engagement with each other so as to form a connection (e.g., a coupling or an attachment) between the first member 201 and the second member 202. Due to the linear expansion of the first linear edge 210 as well as that of the second linear edge 220 along the z-direction, the connection (e.g., the coupling or the attachment) allows for linearly shifting the first member 201 relative to the second member 202 in or against the z-direction.

In more detail, to use the simple joint illustrated in FIG. 11A, the first member 201 may be connected to the first plate of a beam as described above, and the second member 202 may be connected to the second plate of the beam. For example, the upper dovetail joint (e.g., formed by the upper groove 21 and the upper tongue 32) of the intermediate beam 10 illustrated in FIGS. 1 and 3A may be replaced by the joint shown in FIG. 11A. However, depending on a width of the slit, rotation of the first member 201 relative to the second member 202 around the z-axis may be possible to a certain degree. In order to avoid an undesired rotational degree of freedom between the first plate and the second plate of the beam, two of the joints may be used to connect the first plate with the second plate. For example, in the intermediate beam 10 illustrated in FIGS. 1 and 3A, both the upper dovetail joint (e.g., the upper groove 21 and the upper tongue 32) and the lower dovetail joint (e.g., the lower groove 22 and the lower tongue 31) may each be replaced by a joint of the type shown in FIG. 11A.

Irrespective of the type of coupling means used to connect (e.g., couple or attach) the first plate and second plate to each other in a beam, in some embodiments, at least two connections/joints arranged with a suitable distance to each other may be provided to increase the rotational stability of the established connection (e.g., coupling or attachment) of the plates (e.g., to avoid or reduce rotations of the plates relative to each other).

To facilitate the establishment of the connection with the joint as illustrated in FIG. 11A, a part of the first linear edge 210 may include a skewed plane 210a (e.g., a plane 210a that is inclined), in which the first member 201 extends. This is schematically illustrated in FIG. 11B. Then, the diameter of the first linear edge 210 is reduced in a direction perpendicular to or substantially perpendicular to the skewed plane 210a when compared to the diameter of the first linear edge 210 in a direction perpendicular to or substantially perpendicular to the plane, in which the first member 201 extends. Accordingly, the first linear edge 210 may be pushed into the second linear edge 220 through the slit of the second linear edge 220, when the first linear edge 210 is led through the slit in a direction X parallel to or substantially parallel to the skewed plane 210a (the direction X not being parallel to the z-direction as shown in FIG. 11A). When the second member 202 is subsequently rotated relative to the first member 201 around the z-direction (e.g., in a clockwise rotational direction from the perspective of FIG. 11B), the connection (e.g., the coupling or attachment) between the first member 201 and the second member 202 is established, as illustrated schematically in FIG. 11C.

Another type of connection that may be used to realize the coupling means according to embodiments of the present disclosure is a clip joint as schematically illustrated in FIG. 12. In FIG. 12, a first member 310 is connected to a second member 320. The first member 310 may be connected to a first plate of the beam as described above with reference to FIGS. 1 and 3A, and the second member 320 may be connected to the second plate of the beam. Each of the first member 310 and the second member 320 extends linearly along the z-direction. The first member 310 includes a pair of inclined surfaces (e.g., a first inclined surface 311a and a second inclined surface 311b) extending toward each other in a direction towards the second member 320. A first elevation 312a is arranged on the first inclined surface 311a, and correspondingly, as second elevation 312b is arranged on the second inclined surface 311b. Each of the elevations 312a, 312b extends linearly along the z-direction.

The second member 320 includes a pair of parallel planes (e.g., a first plane 321a and a second plane 321b). A first hook 322a is arranged at an edge of the first plane 321a on a side facing the second plane 321b, and correspondingly, a second hook 322b is arranged at an edge of the second plane 321b on the side facing the first plane 321a. Each of the hooks 322a, 322b extends linearly along the respective edge of the respective plane 321a, 321b in the z-direction. The pair of inclined surfaces 311a, 311b of the first member 310 is configured to be shifted into the space between the planes 321a, 321b, such that the first inclined surface 311a comes into contact with the first plane 321a, and correspondingly, the second inclined surface 311b comes into contact with the second plane 321b, as illustrated in FIG. 12. In this state, the first hook 322a arranged on the first plane 321a engages with the first elevation 312a arranged on the first inclined surface 311a, and correspondingly, the second hook 322b arranged on the second plane 321b engages with the second elevation 312b arranged on the second inclined surface 311b. In other words, the pair of inclined surfaces 311a, 311b and the pair of hooks 322a, 322b establish a clip joint. Due to the above-described construction of the clip joint, the first member 310 may be slid or shifted in or against the z-direction relative to the second member 320, while any other displacement as well as rotations of the first member 310 and the second member 320 relative to each other are impeded by the illustrated clip joint.

Another type of connection that may be used to realize the coupling means according to embodiments of the present disclosure is the joint schematically illustrated in FIG. 13, which may be a further type of clip joint. In FIG. 13, a first member 410 is connected to a second member 420. The first member 410 may be connected to a first plate of the beam as described above with reference to FIGS. 1 and 3A, and the second member 420 may be correspondingly connected to the second plate of the beam. Each of the first member 410 and the second member 420 extends linearly along the z-direction, and exhibits a planar shape (e.g., an essentially planar shape). The first member 410 includes a first protrusion 412 protruding perpendicularly or substantially perpendicularly (e.g., essentially perpendicularly) from the first member 410. At the tip of the first protrusion 412, a first hook 412a is arranged. Both, the first protrusion 412 and the first hook 412a extend linearly along the z-direction. At an edge of first member 410, a nose 411 is arranged, which likewise extends linearly along the z-direction. The nose 411 protrudes slightly inclined with respect to the plane of first member 410 on the side of the first member 410 on which the first protrusion 412 is also arranged. The profile of nose 411 may be curved.

The second member 420 includes an edge 421a being thickened in comparison to a thickness of the plane of the second member 420 at positions other than the edge 421a. A clip member 422 protrudes from one side of the second member 420. The clip member 422 extends linearly along the z-direction. The cross-sectional profile of the clip member 422 that is perpendicular to or substantially perpendicular to the z-direction is buckled and protrudes over the thickened edge 421a of the second member 420. In more detail, the clip member 422 includes a first buckle 422a and a second buckle 422b. Accordingly, the clip member 422 includes a first portion 422-1 between the plane of the second member 420 and the first buckle 422a of the clip member 422, a second portion 422-2 between the first buckle 422a and the second buckle 422b, and a third portion 422-3 after the second buckle 422b. From the second portion of clip member 422, a second protrusion 421c is arranged that protrudes toward the extension of the plane, in which the second member 420 extends. Each of the buckles 422a, 422b and each of the portions 422-1, 422-2, 422-3 of the clip member 422 extends linearly along the z-direction. Due to this arrangement, a cave is formed between the thickened edge 421a of the second member 420, the first portion 422-1 of the clip member 422, and the second protrusion 421c. In more detail, the cave is shaped such that the nose 411 of the first member 410 may be accommodated in the cave. After the second buckle 422b, the clip member 422 bends into the third portion 422-3, which is arranged such as to protrude towards the extension of the plane, in which second member 420 extends. At the tip of the third portion 422-3, a second hook 422c is arranged.

To connect the first member 410 with the second member 420, the nose 411 of first member 410 is led into the cave formed by the thickened edge 421a of second member 420, the first portion 422-1 of clip member 422, and the second protrusion 421c as described above. In this state, the first member 410 and the second member 420 are rotatable (up to some degree) with respect to each other around an axis directed along the z-direction through the interior of the cave. To fix the connection, the first member 410 may be rotated with respect to the second member 420, such that the first protrusion 412 of the first member 10 overlaps, within an area, with the third portion 422-3 of the clip member 422 of the second member 420, such that the first hook 412a engages with the second hook 422c. Once the first hook 412a is engaged with the second hook 422c, any rotational movement as well as any translational displacement of the first member 410 relative to the second member 420 is prevented or substantially prevented, except for a translational shift of the first member 410 and the second member 420 relative to each other in or against the z-direction.

Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### REFERENCE SIGNS

10, 10ᵢ₊₁ intermediate beam
10a first end beam
10b, c, d, e, f intermediate beams
10z second end beam
11, 11A, 11B, 11b, 11c, 11ᵢ₊₁ first plate
11A₁, 11A₂ sub-plates
11vs void space
12, 12A, 12B, 12b, 12c, 12ᵢ₊₁ second plate
21, 22 grooves
21ᵢ₊₁, 22ᵢ₊₁ grooves
21a ground part
21b, 21c walls
21b′, 21c′ end parts
31, 32 tongues
31ᵢ₊₁, 32ᵢ₊₁ tongues
32a, 32b inclined parts of a tongue
41, 41ᵢ₊₁, 42, 42ᵢ₊₁ cooling channels
51, 52 through-holes
61, 62 closing members
61a, 61b, 62a, 64, 65 flanges
71, 72 reinforcing strut
80a, 80b, 80c, 80w, 80x, 80y, 80z rows of stacked battery cells
80i, 80ᵢ₊₁ rows of stacked battery cells
80a₁, 80a₂ battery cell stacks
81, 82 adhesive layers
88 battery cell
89 holding means
90 through-hole in front bar
92, 94 front and rear bar
98 grip or handle
100, 100A battery pack
111, 112 first side and second side of first plate
121, 122 first side and second side of second plate
121B, 122B first side and second side of second end plate
201, first member
202 second member
210 first linear edge
210a skewed plane
220 second linear edge
310 first member
311a, 311b inclined surfaces
312a, 312b elevations
320 second member
321a, 321b planes
322a, 322b hooks
410 first member
411 nose
412 first protrusion
412a first hook
420 second member
421a thickened edge
421c second protrusion
422 clip member
422-1, 422-2, 422-3 portions
422a, 422b buckles
422c second hook
6111, 6112, 6121, 6122 flanges on first plate
6121ᵢ₊₁, 6122ᵢ₊₁ flanges on first plate
6211, 6212, 6221, 6222 flanges on second plate
6221ᵢ₊₁, 6222ᵢ₊₁ flanges on second plate
A arrow
B bulge
C cave
D, −D arrows
dc, do diameters
H arrow indicating heat propagation
L₁, L₂, L₃, L₄, L₅, L₆ contact areas of heat exchange
O opening
P1, P2 structures
R rear end of cave
S space
S1, S2 surfaces
T thermal runaway
x, y, z axes of a Cartesian coordinate system
X direction

What is claimed is:

1. A frame for a battery pack having at least two rows of stacked battery cells, the frame comprising:
a first end beam;
a second end beam; and
one or more intermediate beams between the first end beam and the second end beam;
wherein each of the first end beam, the second end beam, and the one or more intermediate beams is orientated along a first direction that is perpendicular to a virtual plane, and comprises:
a first plate having a first side, and a second side opposite to the first side of the first plate;
a second plate having a first side, and a second side opposite to the first side of the second plate; and
a coupling means slidably coupling the second side of the first plate to the second side of the second plate to inhibit any displacement of the first plate relative to the second plate, except for a shifting of the first plate relative to the second plate in or against the first direction.

2. The frame according to claim 1, wherein the coupling means of each of the first end beam, the second end beam, and the one or more intermediate beams comprises:
a first guiding means comprising one or more first guide rails; and
a second guiding means comprising one or more second guide rails,
wherein each of the one or more first guide rails is fixedly on a surface of the second side of a corresponding first plate, and extends linearly along the first direction;
wherein each of the one or more second guide rails is fixedly on a surface of the second side of a corresponding second plate, and extends linearly along the first direction; and
wherein at least one of the first guide rails and at least one of the second guide rails are engaged with each other.

3. The frame according to claim 2, wherein for at least one pair of a first guide rail and a second guide rail that are engaged with each other:
the first guide rail has a first cross-sectional profile in a first plane perpendicular to the first direction and intersecting the first guide rail, independent from a position of the first plane with respect to the first direction; and
the second guide rail has a second cross-sectional profile in a second plane perpendicular to the first direction and intersecting the second guiding means, independent from a position of the second plane with respect to the first direction, and
wherein:
the first cross-sectional profile comprises a cavity having an opening, and the second cross-sectional profile comprises a bulge configured to fit into the cavity, the bulge being connected to a remaining second cross-section profile by a connection part passing through the opening of the cavity; or
the second cross-sectional profile comprises a cavity having an opening, and the first cross-sectional profile comprises a bulge configured to fit into the cavity, the bulge being connected to a remaining first cross-section profile by a connection part passing through the opening of the cavity.

4. The frame according to claim 2, wherein the coupling means of at least one of the first end beam, the second end beam, and the one or more intermediate beams comprises at least one pair of a first guide rail and a second guide rail, the first guide rail and the second guide rail of the at least one pair being engaged with each other as a dovetail joint.

5. The frame according to claim 1, wherein each of the first end beam, the second end beam, and the one or more intermediate beams comprises:
one or more cooling channels on a surface of the second side of the first plate;
and/or one or more cooling channels on a surface of the second side of the second plate.

6. The frame according to claim 1,
wherein for an intermediate beam from among the one or more intermediate beams, the first side of the first plate is configured to support a lateral side of a first row of stacked battery cells, and the first side of the second plate is configured to support a lateral side of a second row of stacked battery cells;
wherein for the first end beam, the first side of the second plate is configured to support another lateral side of the first row of stacked battery cells; and
wherein for the second end beam, the first side of the first plate is configured to support a lateral side of a third row of stacked battery cells or another lateral side of the second row of stacked battery cells.

7. The frame according to claim 1, wherein the first side of the first plate and the first side of the second plate each comprises at least one flange configured to support lateral sides of a row of stacked battery cells.

8. The frame according to claim 1, wherein for each of the first end beam, the second end beam, and the one or more intermediate beams:
a surface of the second side of the first plate has a trapezoidal shape extending between two parallel edges, each being orientated along the first direction; and
a surface of the second side of the second plate has a trapezoidal shape extending between two parallel edges, each being orientated along the first direction.

9. The frame according to claim 1,
wherein, for the first end beam, the first side of the first plate is configured to be mounted to an external structure; and/or
wherein, for the second end beam, the first side of the second plate is configured to be mounted to an external structure.

10. The frame according to claim 1, further comprising:
a front bar orientated perpendicular to the first direction, and configured to be mechanically connected to each of the first end beam, the second end beam, and the one or more intermediate beams at their proximal ends when viewed in the first direction; and/or
a rear bar orientated perpendicular to the first direction, and configured to be mechanically connected to each of the first end beam, the second end beam, and the one or more intermediate beams at their distal ends when viewed in the first direction.

11. A battery pack, comprising:
at least two rows of stacked battery cells; and
the frame according to claim 1,
wherein a number of the one or more intermediate beams equals a number of rows of the at least two rows of stacked battery cells minus one; and
wherein each of the rows of the at least two rows of stacked battery cells is mounted between a corresponding pair of adjacent beams.

12. The battery pack according to claim 11, wherein each of the rows of the at least two rows of stacked battery cells is mounted to the corresponding pair of adjacent beams using layers of adhesives.

13. A vehicle comprising a power source comprising the battery pack according to claim 11.

14. A method of assembling trays of stacked battery cells in a battery pack, comprising:
a1) providing at least two rows of stacked battery cells;
a2) providing a first plate and a second plate for a first end beam;
a3) providing a first plate and a second plate for a second end beam; and
a4) providing a first plate and a second plate for each of one or more intermediate beams, a number of the first plates for the one or more intermediate beams being equal to a number of the second plates for the one or more intermediate beams, and also being equal to a number of rows of the at least two rows of stacked battery cells minus one,
wherein each of the first plate and the second plate has a first side and a second side,
wherein the first plate and the second plate for the first end beam are configured to be coupled to each other at their respective second sides to form the first end beam, the coupling inhibiting any displacement of the first plate relative to the second plate, except for a shifting of the first plate relative to the second plate in or against an elongate direction of the first end beam,
wherein the first plate and the second plate of the second end beam are configured to be coupled to each other at their respective second sides to form the second end beam, the coupling inhibiting any displacement of the first plate relative to the second plate, except for a shifting of the first plate relative to the second plate in or against an elongate direction of the second end beam,
wherein the first plate and the second plate of each of the one or more intermediate beams are configured to be coupled to each other at their respective second sides to form a corresponding one of the one or more intermediate beams, the coupling inhibiting any displacement of the first plate relative to the second plate, except for a shifting of the first plate relative to the second plate in or against an elongate direction of the corresponding one of the one or more intermediate beams, and
wherein the method further comprises:
b) forming a first end tray by mounting one of the rows of stacked battery cells between the first side of the second plate of the first end beam and the first side of the first plate of one of the one or more intermediate beams;
c) forming a second end tray by mounting another one of the rows of stacked battery cells between the first side of the second plate of the one or another one of the one or more intermediate beams and the first side of the first plate of the second end beam; and
d) when the number of rows of stacked battery cells is greater than two:
forming an intermediate tray for each of the remaining rows of stacked battery cells, each of the intermediate trays being formed by mounting another one of the rows of stacked battery cells between the first side of the second plate of an intermediate beam not yet mounted to a row of stacked battery cells and the first side of the first plate of a further intermediate beam not yet mounted to a row of stacked battery cells.

15. A method for assembling a battery pack with a frame, the method comprising:
e) generating trays of stacked battery cells according to the method of claim 14;
f) assembling the first end beam by coupling the second side of the first plate of the first end beam with the second side of the second plate of the first end beam;
g) assembling the second end beam by coupling the second side of the first plate of the second end beam with the second side of the second plate of the second end beam; and
h) when the number of rows of stacked battery cells equals two, such that the number of the one or more intermediate beams equals one, connecting the first end tray with the second end tray to each other by assembling the one intermediate beam by coupling the second sides of the first plate and the second plate of the one intermediate beam to each other; or
i) when the number of rows of stacked battery cells is larger than two:
i1) connecting the first end tray with an intermediate tray by assembling an intermediate beam by coupling the second side of the uncoupled second plate of the intermediate beam used in the first tray with the second side of the first plate used in one of the intermediate trays;
i2) when there is a further unconnected intermediate tray, connecting the further unconnected tray by assembling an intermediate beam by coupling the second side of the uncoupled first plate of an intermediate beam used in the intermediate tray connected in the foregoing step to the second side of the second plate of an intermediate beam used in the further intermediate tray;
i3) repeating step i2) until there is no further unconnected intermediate tray; and
i4) connecting the second end tray by assembling an intermediate beam by coupling the second side of the uncoupled first plate of an intermediate beam used in the intermediate tray, which has been connected last in the foregoing sub-step i1) or i2), to the second side of the second plate of the intermediate beam used in the second end tray.
